(19) United States
(12) Patent Application Publication
(10) Pub. No.: US 2019/0135501 A1
(43) Pub. Date: May 9, 2019

(54) BOTTLES WITH SMART LABELS, AND METHODS OF MAKING SMART LABELS FOR BOTTLES AND LABELING BOTTLES WITH SUCH SMART LABELS

(71) Applicant: Thin Film Electronics ASA, OSLO (NO)

(72) Inventors: Aditi CHANDRA, Los Gatos, CA (US); David ULAND, Granville, OH (US); Alex CHANDLER, Sunnyvale, CA (US)

(21) Appl. No.: 16/094,169

(22) PCT Filed: Apr. 18, 2017
(86) PCT No.: PCT/US2017/028135

§ 371 Date: Oct. 16, 2018

Related U.S. Application Data
(60) Provisional application No. 62/324,196, filed on Apr. 18, 2016.

(51) Int. Cl. B65D 41/62; G06K 19/077

(52) U.S. Cl. CPC B65D 41/62; G06K 19/07798; B65D 2203/10; B65D 2101/0023; B65D 2101/0007

(57) ABSTRACT

A bottle having a sealing device and a substrate attached thereto, and methods of attaching the substrate to the bottle are disclosed. Methods include placing the substrate on the bottle, the bottle having a break line, and the substrate having a wireless communication device having an antenna, an integrated circuit, and a sensing line thereon. Methods further include adhering a first part of the substrate including the antenna to a first portion of the bottle that does not include the break line, and a second part of the substrate including the sensing line to a second portion of the bottle and on/over a break line. The bottle includes an interface between the sealing device and defines a break line. The substrate including the wireless communication device is on/over the bottle, at least a part of the sealing device and the break line.

### CROSS REFERENCE TO RELATED APPLICATION

This application claims the benefit of U.S. Provisional Pat. Appl. No. 62/324,196, filed on Apr. 18, 2016, incorporated herein by reference as if fully set forth herein.

### FIELD OF THE INVENTION

The present invention generally relates to the field(s) of product security and authentication. More specifically, embodiments of the present invention pertain to methods of attaching a substrate (e.g., label) to a bottle, the substrate having an electronic tag and/or device (which may communicate wirelessly) with a mechanism for detecting an opened or tampered state of the bottle, and a bottle having such a substrate attached thereto.

### DISCUSSION OF THE BACKGROUND

Counterfeiting and diversion (sale of a product outside an authorized region or through an unauthorized distributor, also known as “gray market activity”) are two common problems impacting global supply chains and global brands. Apart from the obvious loss of revenue from the sale of genuine products, brands are negatively impacted by counterfeiting when an unknowing consumer loses confidence in a product's quality or safety. In the case of gray market activity, the brand company might receive revenue for the sale of genuine product in an area where it is not distributed, but the unauthorized sales could compromise country- and region-specific pricing. In addition, taxing authorities might not be properly reimbursed if product is sold outside the intended region. This potential loss of revenue also makes governments stakeholders in counteracting gray market activity.

Product manufacturers often turn to different technologies to protect against counterfeiting and diversion. Holograms are very common and can be read in the field, but are increasingly easy to forge. Sophisticated, “forensic”-type verification generally requires shipment of questionable product to a certified lab for analysis and verification. However, such methods cannot be used for real-time, in-field analysis and decision making.

In order to overcome the limitations of holograms and enhance the level of security, while preserving the ability to verify authenticity in the field (for example, at customs inspection, at a retail store, or in a restaurant), manufacturers of certain products, including premium products such as alcoholic beverages, look to wireless solutions that combine RFID tags with reader devices. One particularly convenient implementation—due to the wide availability of NFC-capable smartphones (500 million in use by 2014 and 1 billion to be sold worldwide from 2014 and 2015) combines NFC (13.56 MHz high frequency [HF] RFID) tags with NFC-capable smartphones. In this implementation, NFC tags are placed in such a way that opening the protected product, such as opening a bottle by twisting a cap or removing a cork, destroys the NFC tag, generally by breaking the antenna in some way (for example, poking the antenna with a corkscrew or twisting and breaking the antenna in the act of opening a screw-top container). This means that cloud services that authenticate protected items based on the NFC tag's ID cannot be used after the protected item has been opened.

FIG. 1 shows a conventional bottle labeling machine 1, designed as a rotating machine for labeling bottles with labels 3 (for example, wrap-around labels). The labeling machine 1 includes a rotor 4 that is driven in a rotating manner in the direction of the arrow A around a vertical machine axis with large numbers of formed supporting bases provided on the circumference of the rotor 4 in the form of turntables 5 in each case to receive one bottle 2. The bottles 2 for labeling are guided to the rotor 4 via a conveyor 6 on a bottle in-feed, so that in each case one bottle 2 is arranged standing upright on a turntable 5 (e.g., with the bottle axis pointing vertically upwards). The bottles, amongst other things, are circulated on the rotor 4. A labeling unit 7, which has a gluing device 12 and a label 3 with a protruding labeling end 3.1 on the circumference of a vacuum drum 8, transfers the label 3 to the bottle 2 by wrapping or pressing while the bottle 2 rotates and the label 3 is removed from the vacuum drum 8. The labeled bottles 2 are further conveyed again on the conveyor 6 to a container or a bottle discharge device on the conveyor 6 for removal.

Vacuum holders or vacuum pads 9 and 9a are provided with vacuum openings for holding the labels onto the circumferential surface of the cylindrically-shaped vacuum drum 8, which is driven around a vertical axis synchronously with the rotor 4, but in the opposite rotational direction (i.e., in the direction of the arrow B). A vacuum pad 9 holds the respective label 3 on its protruding end 3.1 in the rotating direction of the vacuum drum 8, and a vacuum pad 9a holds each label 3 on the successively guided end of the label 3.2 that is in relation to the rotating direction of the vacuum drum 8. The vacuum pads 9 and 9a are fitted in pairs and in an angled separation, which is the substantially same as the length of the label 3.

The labels 3 are produced from a carrier web or labeling material 3a that is in strips and which is detached in the direction of the arrow C by being cut-off or separated from a supply point (e.g., a supply spool; not illustrated). The carrier web 3a is guided to the labeling unit 7 via a plurality of rollers 11 and a motor-driven detaching device 12, and arrives at a cutting roller 13, where the label 3 is separated from the carrier web 3a and transferred to the vacuum drum 8. Each label 3 held on the vacuum drum 8 with the vacuum pads 9 and 9a is moved past a gluing station 14 that applies glue on at least the protruding ends 3.1 and 3.1 of the label 3. When the glue is to be applied only on the protruding ends 3.1 and 3.2 of each label 3, the strip-like vacuum pads 9 and 9a may be positioned with their lengthways side oriented parallel to the rotating axis of the vacuum drum 8 and projected above the circumferential surface of the vacuum drum 8.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to methods of attaching a substrate (e.g., a “smart label”) to a bottle, the substrate having a tag and/or device (which may communicate wirelessly, for example by radio frequency [RF and/or RFID] and/or near field communication [NFC]) with a mechanism for detecting a continuity state of the bottle, and a bottle having such a substrate attached thereto.

In one aspect, the present invention relates to a method of attaching a substrate to a bottle that includes placing the substrate on the bottle, the bottle having a break line, and the substrate having a wireless communication device having an antenna, an integrated circuit, and a sensing line thereon, and adhering (i) a first part of the substrate including the antenna to a first portion of the bottle and (ii) a second part of the substrate including the sensing line to a second portion of the bottle and on or over the break line. The first portion of the bottle does not include the break line. Alternatively, the wireless communication device may include a display instead of the antenna, and the substrate or label may optionally include a corresponding window for the display.

In various embodiments of the present invention, prior to placing the substrate on the bottle, the substrate is held on a vacuum surface (e.g., a vacuum pad or vacuum drum) and applied to the bottle from the vacuum surface. The vacuum surface comprises at least one vacuum holder or pad configured to hold the substrate to the vacuum surface. Each vacuum holder or pad may have one or more vacuum openings therein.

In further embodiments of the present invention, the substrate comprises paper, a glass/polymer laminate, a paper/polymer laminate, a high temperature polymer, or a metal foil. The high temperature polymer (which may also be in the glass/polymer and/or paper/polymer laminates) may comprise or consist of a polyimide, a polyethersulfone, polyethylene naphthalate (PEN), or a polyether ether ketone (PEEK). The metal foil may consist of an aluminum, stainless steel, or copper foil. In exemplary embodiments of the present invention, the substrate comprises a label. Alternatively, the label may be separate from the substrate, in which case the method further comprises placing the label on and adhering the label to the substrate on the bottle. Generally, the bottle includes a neck, a shoulder, and a body.

In further embodiments of the present invention, placing the substrate on the bottle may include applying the substrate from a carrier web (e.g., labeling material) using one or more rollers. The carrier web may consist of paper, semi-gloss paper, film, a transparent or non-transparent film, a paper/polymer laminate, a glass/polymer laminate, a high temperature polymer, a metal foil such as aluminum, stainless steel or copper foil, or a combination thereof. Detaching the substrate from a carrier web may be accomplished using a detaching device and/or a cutting roller, prior to transferring the substrate to the vacuum surface. Thus, the substrate is transferred to the vacuum surface after the substrate is detached from the carrier web or labeling material (which may be, e.g., on a label spool). Additionally or alternatively, prior to placing the substrate on the bottle, the substrate may be guided to a gluing or adhesive station configured to apply glue or another adhesive to the substrate.

In various embodiments of the present invention, the integrated circuit may have a first set of terminals electrically connected to the antenna. Also, the integrated circuit may have one or more terminals electrically connected to the sensing line(s). Typically, the sensing line terminal(s) are separate from the first set of terminals. Generally, the antenna is configured to receive and transmit (or broadcast) wireless signals.

In exemplary embodiments of the present invention, the break line includes an interface between the bottle and a sealing device or mechanism on or in the bottle. Typically, the sealing device or mechanism comprises a cap, a lid, a cork, and/or a stopper. In some embodiments of the present invention, a cork or cork stopper may be placed in the bottle. Placing the substrate on the bottle may comprise or consist of applying the substrate to the bottle and the sealing device or mechanism, and applying pressure to the substrate. In exemplary embodiments of the present invention, the substrate comprises a slit, a notch, a score, and/or a perforation over the break line. The slit, notch, score, and/or perforation are configured to facilitate breaking, tearing, or severing the substrate and the sensing line.

In further embodiments of the present invention, a center part of the substrate may be applied to an uppermost surface of the sealing device or mechanism. The first part of the substrate including the antenna and integrated circuit may be placed on and adhered to the neck of the bottle. Additionally or alternatively, the first part of the substrate including the antenna and the integrated circuit may be on or over the shoulder of the bottle and/or on or over the body of the bottle. The second part of the substrate including the sensing line may be placed on or over the sealing device or mechanism and the neck of the bottle, and adhered to at least the neck of the bottle.

In some embodiments of the present invention, the bottle may be guided to a second labeling unit configured to adhere or press at least part of the second part of the substrate including the sensing line to the neck of the bottle, and adhere or press at least part of the first part of the substrate including the antenna and integrated circuit to the neck and/or shoulder of the bottle. In further embodiments, a shrink wrap or a capsule may be placed over the substrate after adhering the substrate to the bottle. Furthermore, the substrate (and optionally, the sealing device or mechanism) may be secured with the shrink wrap, and/or the capsule using a spinner subsequent to adhering the substrate to the bottle. Heat may be applied to the shrink wrap or capsule to activate the adhesive and adhere the part of the substrate having the sensing line(s) to the shrink wrap or capsule.

In various embodiments of the present invention, placing the substrate on the bottle may include attaching the first part of the substrate having the antenna and integrated circuit to the shoulder of the bottle and attaching the second part of the substrate having the sensing line on the neck of bottle, on or over the break line, and on at least a side surface of the sealing device or mechanism. Alternatively, the second part of the substrate including the sensing line may be placed on at least one side surface and the top of the sealing device or mechanism. Attaching the substrate to the bottle may include attaching the first part of the substrate including the antenna and integrated circuit on the side of the sealing device or mechanism, and attaching the second part of the substrate including the sensing line on the neck and/or the shoulder of the bottle. The side of the sealing device or mechanism may include a side surface having a circular or oval cross-section. The first part of the substrate including the antenna and integrated circuit may cover at least a 60° arc (e.g., a 90-180° arc) along the side surface of the sealing device or mechanism.

In further embodiments of the present invention, the sensing line may include a plurality of sensing lines on the second part of the substrate. For example, one sensing line can be on the neck of the bottle, over the break line, and on a first side surface of the sealing device or mechanism, and another sensing line can be in the same locations as the one sensing line and also on or over the top of the sealing device or mechanism, a second side surface thereof, and an opposite side of the neck of the bottle, over the break line in a second location.

In exemplary embodiments of the present invention, the bottle may be transported to at least one labeling unit. Generally, the bottle is transported using a conveyor. In addition, transporting the bottle to the labeling unit may include guiding the bottle to a rotor and circulating the bottle using a turntable.

In another aspect, the present invention relates to a bottle having a sealing device or mechanism thereon and a substrate attached thereto. A wireless communication device is on the substrate. An interface between the sealing device or mechanism and the bottle defines a break line. The substrate is on or over the bottle, at least a part of the sealing device or mechanism, and the break line. The wireless communication device includes an antenna, integrated circuit, and a sensing line. The sensing line is on or over the break line. Alternatively, the wireless communication device may include a display instead of the antenna, and the substrate or label may optionally include a corresponding window for the display.

Generally, the bottle comprises a neck, a shoulder, and a body. Typically, the sealing device or mechanism comprises a cap, a lid, a cork, and/or a stopper.

In various embodiments of the present invention, the second part of the substrate may include a slit, notch, and/or perforation over the break line. The slit, notch, and/or perforation are configured to facilitate breaking, tearing, or severing the substrate and the sensing line.

In further embodiments of the present invention, the substrate may include paper, a glass/polymer laminate, a paper/polymer laminate, a high temperature polymer, or a metal foil. The high temperature polymer (which may also be in the glass/polymer and/or paper/polymer laminates) may include a polyimide, a polyethersulfone, polyethylene naphthalate (PEN), or a polyether ether ketone (PEEK). The metal foil may include an aluminum, stainless steel or copper foil. In exemplary embodiments of the present invention, the substrate may include a label. Alternatively, the label may be separate from the substrate, in which case the label may be on or over the substrate on the bottle.

In various embodiments of the present invention, a first part of the substrate having the antenna and integrated circuit thereon may be on the neck, the shoulder, and/or the body of the bottle (e.g., the neck and/or the shoulder). A second part of the substrate including the sensing line may be on the neck of the bottle, on a side surface of the sealing device or method, and on or over the break line. Additionally, the present invention may include a shrink wrap or a capsule on or over the substrate.

In further embodiments of the present invention, the first part of the substrate with the antenna and integrated circuit is on the neck and/or shoulder of the bottle, and the second part of the substrate with the sensing line is on the neck of the bottle, on or over the break line, and on a side of the sealing device or mechanism. Alternatively, the first part of the substrate with the antenna and integrated circuit is on the side or top of the sealing device or mechanism, and the second part with the sensing line on the neck and/or shoulder of the bottle and over the break line. The side of the sealing device or mechanism may have surface with a circular or oval cross-section, and the second part of the substrate including the sensing line may cover at least a 90° arc (e.g., a 90-180° arc) of the side surface of the sealing device or mechanism.

In an even further embodiment, the first part of the substrate including the antenna and the integrated circuit may be on a shoulder of the bottle, and the second part of the sensing line may be on the neck, on or over the break line, and a side and/or top of the sealing device or mechanism. In various embodiments, an adhesive may be applied between the bottle and the substrate. Additionally or alternatively, a first adhesive may be between the bottle and the sensing line, and a second adhesive may be between the sensing line and the substrate.

In some embodiments, the wireless communication device may include a receiver and a transmitter, each in electrical communication with the antenna. The integrated circuit may be configured to (i) process a first wireless signal and/or information therefrom, and (ii) generate a second wireless signal and/or information therefor. Typically, the integrated circuit has a first set of terminals electrically connected to the antenna. The integrated circuit generally includes a continuity sensor electrically connected to the sensing line, configured to sense or determine a continuity state of the bottle. The integrated circuit may include one or more printed layers. The integrated circuit may include a memory including one or more bits configured to store a value corresponding to the continuity state of the bottle. The memory may further include a plurality of bits configured to store a unique identification code for the bottle. The memory may include at least one printed layer, and the plurality of bits configured to store the unique identification code for the bottle may have a state defined by the printed layer(s).

In further embodiments, the wireless communication device may include a near field (NFC) and/or radio frequency (RF) communication device. The NFC and/or RF device may comprise a transmitter and a receiver, both in electrical communication with the antenna. The transmitter may include a modulator, and the receiver may include a demodulator.

In various embodiments, the antenna may consist of a single metal layer. In a further embodiment, the antenna and the sensing line may consist of a single common metal layer. In an alternative embodiment, the sensing line may include a plurality of sensing lines.

A first one of the plurality of sensing lines may be on first and second opposed sides of the neck and/or shoulder of the bottle and on first and second opposed sides of the sealing device or mechanism, and a second one of the plurality sensing lines may be on only one side of the neck and/or shoulder of the bottle and (a same side) of the sealing device or mechanism.

As a result, the present invention advantageously provides electronic tags (e.g., substrates and/or labels) for bottles having various shapes and/or bottling types that can be easily integrated into existing bottling or bottle labeling systems or machines without making changes to the existing systems or machines. In addition, the present invention advantageously provides electronic tags on substrates or labels having various shapes and possible locations on the bottles to maintain the aesthetic appearance of the bottles (and/or other containers). The present invention may also expand the use and functionality of near field communication and RF tags and devices. The present method of attaching substrates having electronic tags and/or devices thereon to bottles enables continuity sensing (e.g., determining whether the bottle has been opened or tampered with) and continued use of the tags and/or devices to communicate information about the product in the bottle (or container) after the bottle (or container) has been opened. These and other advantages of the present invention will become readily apparent from the detailed description of various embodiments below.

### BRIEF DESCRIPTION OF THE DRAWINGS

FIG. 1 shows a conventional bottle labeling machine.

FIG. 2 shows an exemplary bottle with a substrate placed thereon in accordance with one or more embodiments of the present invention.

FIG. 3A shows an exemplary labeling sheet including a variation of the substrate of FIG. 2, and FIGS. 3B-C show exemplary bottles with the substrate of FIG. 3A placed thereon in accordance with an embodiment of the present invention.

FIG. 4A shows a substrate having an exemplary wireless communication device thereon, and FIG. 4B shows exemplary bottles with a substrate placed thereon, and a label or capsule thereover, in accordance with one or more embodiments of the present invention.

FIGS. 5A-B show an exemplary sheet or roll with substrates having wireless communication devices thereon and cuts or perforations therein, in accordance with one or more embodiments of the present invention. FIG. 5C shows a cross-sectional view of the exemplary wireless communication device of FIGS. 5A-B.

FIGS. 6A-B show exemplary bottles with a substrate placed thereon in accordance with one or more embodiments of the present invention.

FIG. 7 shows an exemplary wireless communication device on a substrate in accordance with one or more embodiments of the present invention.

FIG. 8 shows an exemplary bottle with a substrate on or over a capsule in accordance with one or more embodiments of the present invention.

FIG. 9 shows exemplary bottles with an alternative substrate thereon in accordance with one or more embodiments of the present invention.

FIGS. 10A-B show a further alternative substrate, and FIG. 10C shows an exemplary bottle with the alternative substrate of FIGS. 10A-B thereon in accordance with one or more embodiments of the present invention.

FIG. 11 shows a bottle with a capsule thereon having a removable strip in accordance with one or more embodiments of the present invention.

FIG. 12 shows an exemplary wireless communication device (e.g., an NFC/RF tag) with multiple sensing lines for sensing whether a bottle bearing the device has been opened, in accordance with one or more embodiments of the present invention.

FIGS. 13A-C show exemplary NFC devices with sensing lines for sensing whether a bottle bearing the tag has been opened, in accordance with one or more embodiments of the present invention.

FIG. 14 shows an exemplary integrated circuit for use in the present wireless communication device.

FIG. 15 shows a flow chart for an exemplary method of placing a substrate on a bottle, the substrate having a wireless communication (e.g., NFC and/or RF) device thereon in accordance with one or more embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments.

On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and materials have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the terms “shrink wrap,” “sleeve” and “capsule” are, in general, interchangeable and may be used interchangeably herein, but are generally given their art-recognized meanings. Wherever one such term is used, it also encompasses the other terms. Similarly, the terms “substrate” and “label” may be used interchangeably herein, but are generally given their art-recognized meanings. For example, a substrate can be any physical support for the antenna, integrated circuit and sensing line(s) disclosed herein, but a label has a side or surface that conveys information thereon (e.g., the identity of the product inside the bottle). Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present invention solves problems in conventional solutions where the tag cannot be read after the protected product is opened. The present invention allows reading the tag prior to opening the protected product (to verify that it is authentic and that it has not been opened), as well as after opening the product. Product manufacturers, distributors, resellers, and consumers all have an interest in the ability of the consumer to read the tag after opening, for example, to access product recall notices, read product instructions and marketing information, easily contact support or warranty services, or enable product re-orders or orders of related consumables or accessories.

Furthermore, the present invention adds minimal to no incremental cost to a standard NFC or RF tag implementation. Because the security (sensing) lines are manufactured at the same time that the antenna is manufactured (for example, using aluminum etching or screen printing), there are no additional steps, and very little to no incremental material costs. In one simple embodiment, the antenna metal layer design is adjusted to add one or more additional metal lines (which are NOT part of the antenna coil) that are broken as part of the bottle or container opening process. The additional metal lines (called “sensing lines” herein) are electrically separate from the antenna coil, and may be partially or completely implemented on the side of the antenna substrate opposite the antenna coil. The sensing lines make electrical contact to the integrated circuit (IC) so that the IC can detect whether the sensing lines are intact (or “closed,” the default state at manufacturing) or broken (or “open,” after the protected product has been opened). The substrate material, such as paper or plastic, may be mechanically scored (e.g., cut or perforated) to facilitate breaking the sensing line(s) when the protected product is opened.

The present invention may use a combination of ROM bits (typically as a unique ID) and sensor bits, and contemplates electrical continuity sensing as a state of the container and/or tag. When read by an NFC-capable smart phone or other reading device, the NFC tag's memory bits allocated to sensor data will indicate whether the metal sensing line(s) are intact or broken.

Exemplary Bottles Having Attached Thereto a Substrate With a Wireless Communication Device Thereon

The present invention relates to a bottle having a sealing device or mechanism thereon and a substrate attached thereto. A wireless communication device is on the substrate. An interface between the sealing device or mechanism and the bottle defines a break line. The substrate is on or over the bottle, at least a part of the sealing device or mechanism, and the break line. The wireless communication device includes an antenna, integrated circuit, and a sensing line. The sensing line is on or over the break line.

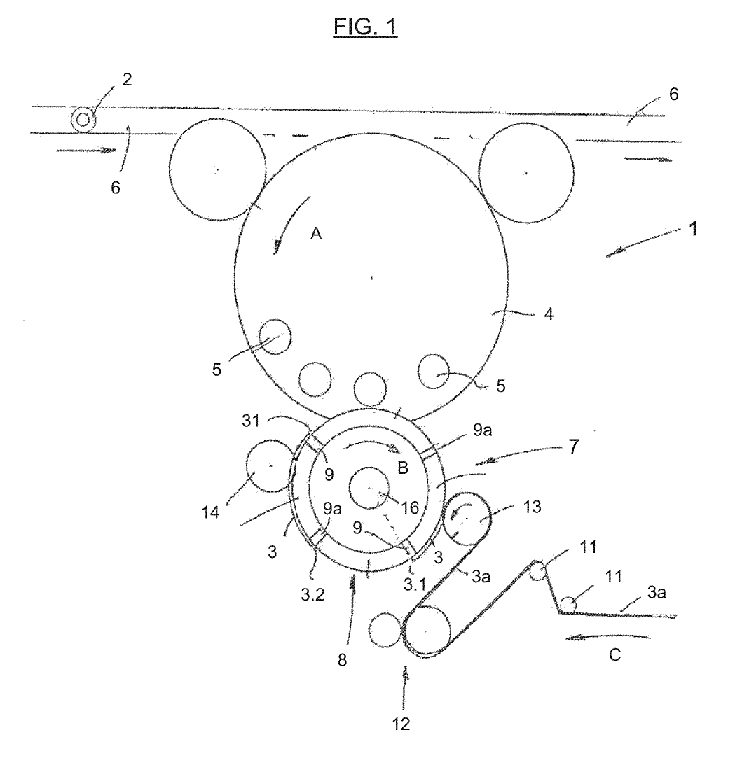

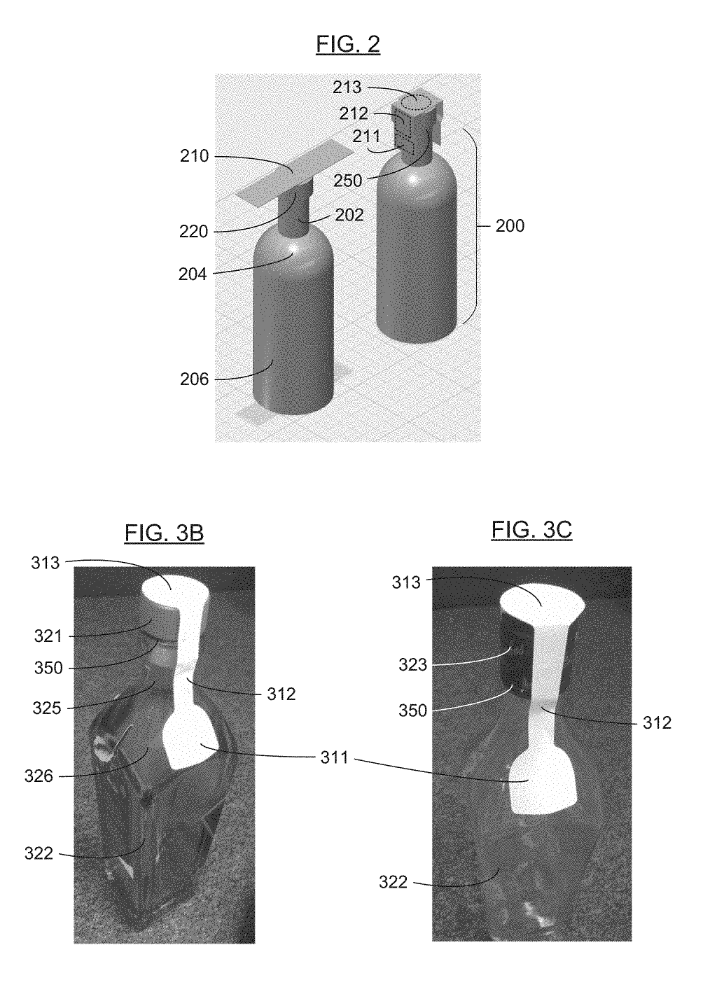

FIG. 2 shows a bottle 200, a sealing device or mechanism (e.g., a cap) 220, and a substrate (e.g., a tax label) 210. The substrate 210 may be placed on the bottle 200 using the bottle labeling machine of FIG. 1, as discussed above, or a similar conventional bottle labeling machine. The bottle 200 may have a neck 202, a shoulder 204, and a body 206. In the example of FIG. 2, the sealing device or mechanism 220 comprises a cap or a lid.

The interface between the bottle 200 and the sealing device or mechanism 220 defines a break line 250.

As shown in FIG. 2, the substrate 210 is a type or example of a tax label, applied over the cap or lid 220 and along opposite sides of the cap or lid 220 and the neck 202 of the bottle 200. The substrate 210 shown in FIG. 2 is rectangular or substantially rectangular, but it may have another shape (e.g., as described herein). The substrate 210 may comprise paper, a glass/polymer laminate, a paper/polymer laminate, a high temperature polymer, and/or a metal foil, as described herein. In some embodiments, the substrate may consist of polyethylene terephthalate (PET), which may be heat stabilized. The metal foil may include an aluminum, stainless steel or copper foil. In exemplary embodiments, the substrate 210 may include a label.

Furthermore, a wireless communication device that includes an antenna, integrated circuit, and a sensing line (not shown) is on the substrate 210, on the surface of the substrate 210 facing the bottle 200 and the cap 220. Thus, the substrate 210 may have a first part 211 including the antenna and integrated circuit (not shown) on or over a first portion of the bottle (e.g., the neck 202), and a second part 212 including a sensing line on or over a second portion of the bottle (e.g., the top of the neck 202), over the break line 250, and on a side surface of the cap or lid 220. Alternatively, the sensing line(s) may be on a second, separate substrate (not shown) from the substrate 210 having the antenna and the integrated circuit thereon. The second substrate having the sensing line(s) thereon may be placed on or over the substrate 210, such that the sensing line electrically connects to the integrated circuit and is over the break line 250.

As shown in FIG. 2, a center part 213 of the substrate 210 is on an uppermost surface of the sealing device or mechanism 220. In an alternative embodiment, the antenna and integrated circuit may be on (and under) the center part 213 of the substrate 210, on or over the sealing device or mechanism 220. In such an alternative embodiment, the second part 212 of the substrate 210 including the sensing line is still on or over the break line 250, the side surface of the sealing device or mechanism 220, and the neck 202 of the bottle 200. When the bottle has a long neck (e.g., a wine bottle having a cork or cork stopper therein and/or shrink wrap over the top part of the neck), the second part 212 of the substrate 210 may be adhered to the neck 202 of the bottle.

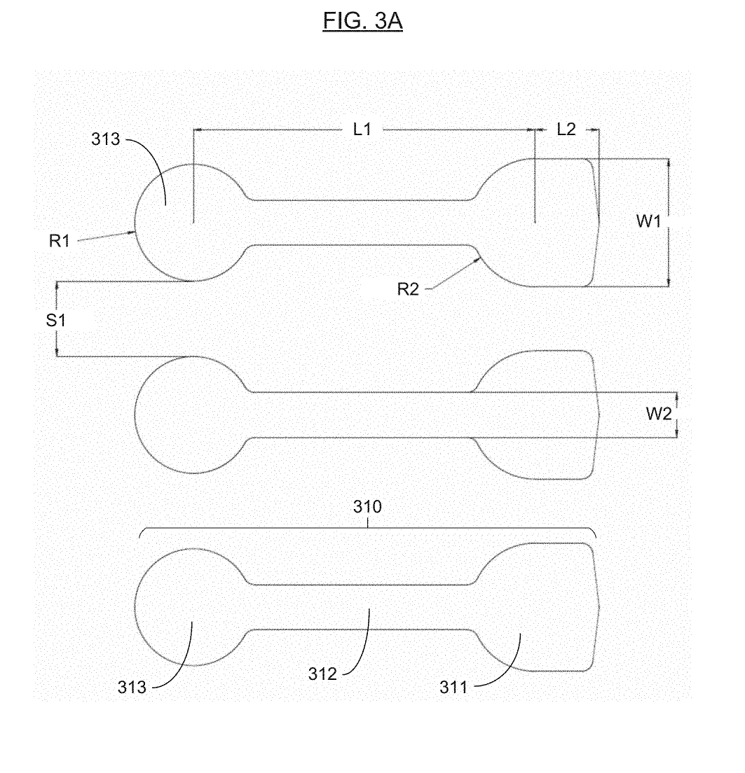

FIG. 3A shows an exemplary labeling sheet including a variation of the substrate 200 (e.g., a relatively simple label and/or a tax label) of FIG. 2, and FIGS. 3B-C show exemplary bottles with the substrate of FIG. 3A placed thereon in accordance with one or more embodiments of the present invention.

FIG. 3A shows exemplary dimensions of the substrate 310 in accordance with one or more embodiments of the present invention. The substrate 310 may include a label, such as a tax label. The substrate 310 may have a first part 311, a second part 312, and a third part 313. The first part 311, which is configured to be placed on the shoulder and/or the body of the bottle, may include the antenna and integrated circuit thereon. Generally, the first part 311 may have a circular shape, as shown in FIG. 3A. However, the first part 311 may have any of various shapes, such as oval, square, rectangular, triangular, pentagonal, hexagonal, or irregular, but the shape of the first part 311 is not limited thereto. The second part 312, which is configured to be placed on side surfaces of the bottle and cap and over the break line, generally includes the sensing line(s) and has a rectangular or tapered shape. The third part 313, which may have (but is not limited to) a round or circular shape, may be placed on/over and/or adhered to an uppermost surface of the sealing device or mechanism.

In addition, the third part 313 may have any of various shapes, such as oval, square, rectangular, triangular, pentagonal, hexagonal, or irregular, and which may match the shape of the first part 311, but the shape of the third part 313 is not limited thereto. The third part 313 of the substrate 310 may include part of the sensing line, or alternatively, the antenna and integrated circuit.

As shown in FIG. 3A, a length L1 from a center of the third part 313 of the substrate 310 to the center of the first part 311 of the substrate 310 may be from about 50 to 300 mm (e.g., from 60 to 200 mm, or any length or range of lengths therein). In one example, L1 is about 90 mm. A length L2 from the center of the first part 311 of the substrate 310 to an end or furthermost peripheral edge of the first part 311 of the substrate 310 may be from about 5 to 300 mm (e.g., from 10 to 100 mm, or any length or range of lengths therein). In one example, L2 is about 16 mm. Also, the first part 311 of the substrate 310 may have a width W1 at its widest point of from about 10 to 300 mm (e.g., from 15 to 200 mm, or any width or range of widths therein). In one example, W1 is about 34 mm. The second part 312 of the substrate 310 may have a width W2 of from about 5 to 100 mm (e.g., from 10 to 50 mm, or any width or range of widths therein). In one example, W2 is about 12 mm. Furthermore, the first part 311 of the substrate 310 may have a rounded peripheral edge with a radius of from about ⅙^{th} to about ½ of W1 (e.g., about 17 mm in one example), depending on the slope or taper along the side edges of the first part 311. The third part 313 of the substrate 310 may have a radius of about 5 to 100 mm (e.g., from 10 to 50 mm, or any radius or range of radii therein). In one example, the radius is about 15 mm. On the label material stock (not shown), the third part 313 of the substrate 310 may have an edge-to-an-edge spacing or distance Si from a neighboring substrate 310 of from about 5 to 200 mm (e.g., from 10 to 100 mm, or any distance or range of distances therein, and in one example, about 20 mm).

In exemplary embodiments, the substrate or label 310 may consist of a paper face having an inlay part in which the second part 312 (e.g., a tail portion) of the substrate 310 is relatively stiff or rigid, compared to the first part 311 or third part 313, thereby providing a more controlled application of the substrate 310 to the bottle. Dimensions of selected regions of the second part 312 of the substrate 310 may be reduced to control placement of the second part 312 of the substrate 310 (e.g., tail placement).

The exemplary substrates of FIGS. 2 and 3A-C may be advantageously applied to bottles of wine and/or spirits using a conventional tax-label applicator. A reader (e.g., an NFC- and/or RF-enabled smart phone) may access the antenna and integrated circuit under the first part 311 or the third part 313 of the label on the bottle. However, access to the antenna and integrated circuit along the neck of the bottle may be relatively challenging, primarily due to placement of the antenna under the first part 311 or the third part 313 of the label.

FIG. 3B shows an exemplary bottle 322 with the substrate 310 (e.g., a pressure sensitive label or tax label) of FIG. 3A placed thereon. The first part 311 of the substrate 310 may include the antenna and integrated circuit thereunder (not shown). The first part 311 may be placed on a shoulder 326 of the bottle 322 using the bottle labeling machine of FIG. 1, as discussed above, or a similar conventional bottle labeling machine. In some embodiments, the second part 312 of the substrate 310 may include a sensing (sense) line (not shown). The second part 312 of the substrate 310 may be on the neck 325 of the bottle 322, on a side of the cap 321, and on or over a break line 350 between the bottle 322 and the sealing device or mechanism (e.g., cap or lid) 321. The third part 313 of the substrate 310 may include the antenna and integrated circuit thereunder (not shown) or the sensing line (not shown). The third part 313 may be placed on an uppermost surface of sealing device or mechanism (e.g., the cap) 326 of the bottle 322 using the bottle labeling machine of FIG. 1, as discussed above, or a similar conventional bottle labeling machine.

As shown in FIG. 3C, tamper evidence, such as a shrink wrap or capsule 323, may be on the sealing device or mechanism 323, over the break line 350, and at least part of the neck 325 of the bottle 322. Alternatively, the substrate 310 may be placed on or over the shrink wrap or capsule 323. The first part 311 of the substrate 310 including the antenna and integrated circuit may be on the shoulder 326 of the bottle 322, the second part 312 of the substrate 310 including the sensing line may be on or over the shrink wrap or capsule 323, the break line 350, and the neck 325 of the bottle 322. A portion of the second part 312 may also be on the shoulder 326 of the bottle 322.

In exemplary embodiments of the present invention, tamper evidence may be placed on or over the interface between the sealing device (e.g., cap) and the bottle (e.g., the break line 350) under a capsule with a charm loop (e.g., a loop with a charm thereon that may be detached from the label when the charm is pulled and used by the individual or worn on the individual's wrist) applied over the second part of the substrate including the sensing line. The sensing line over the interface at the cap and glass boundary (e.g., the break line 350) is generally broken when the charm is pulled. Also, security tabs on the cap 321 or a surface thereof may propagate through the same or different sensing line when the cap 321 is removed. Such a sensing line may remain intact when the user attempts to peel the substrate 310 (e.g., the third part 313) off the cap 321. Also, break tabs at the boundary of the shoulder 326 of the bottle 322 may be applied to prevent the substrate 310 from peeling up. Furthermore, the substrate 310 may be placed under the capsule 323 to minimize the cosmetic impact of the substrate 310.

Generally, a tapered or curved shape to the substrate 310 suggests failing points when the bottle 322 is opened. To detect tampering with the substrate 310, the break line 350 should be in the zone where the sealing device or mechanism (e.g., a cork) is removed from the bottle 322. The substrate 310 in such a case may resemble a bowtie, to preserve a circular form for the antenna (preferably, on a lowermost portion of the neck 325 or the shoulder 326 of the bottle). Preferably, the antenna is below an area of the bottle 322 where the substrate (e.g., label) 310 may be cut (e.g., with a knife or other sharp object) when the cork or other sealing device or mechanism is being removed.

Independent of the shape of the substrate 310, the sensing line may include a non-reversible loop. The loop may have a weak portion, similar to an ink (e.g., a conductive and transparent portion, similar to ITO-based displays), or alternatively, a part of the tamper-evident substrate or label 310 is not adhered to the glass but to the shrink wrap or capsule 323, so when the shrink wrap 323 is removed, the loop is also removed. Also, a conductive adhesives may be used as part of the non-reversible loop. In some embodiments, the sensing line may include a plurality of physically separate segments that may be on different substrates, at least some of which are separated when the bottle is opened. For example, at least part of the sensing line may be printed on paper, and the paper is adhered to the bottle so the sensing line faces away from the bottle. At this point, the sensing line is not complete. A second substrate (e.g., a label) with a conductive adhesive in locations where the sensing line is electrically connected to the IC or a trace to the IC on the label may be placed over the substrate with the sensing line segment thereon or, in the case of multiple substrates with sensing line segments thereon, the uppermost such substrate. When the label is removed (e.g., when the bottle is opened), the paper separates internally (e.g., part of the paper substrate with the sensing line or segment thereof thereon is removed, and part of the paper substrate is left behind on the bottle), or the sensing line comes off the paper. Either way, a portion of the sensing line comes off with the label. Thus, the sensing line is irreversibly broken.

Alternatively, a conductive adhesive may be used to join the sensing line on one substrate to a different substrate with the IC and antenna thereon by printing. For example, sensing lines may be printed at relatively high speed on any of a variety of substrates. However, it may be relatively difficult to tear or break the substrate having the IC and antenna thereon. Thus, conductive pads may be formed on the IC/antenna substrate, and the sensing line may be printed on another substrate and subsequently joined or combined to the conductive pads on the IC/antenna substrate via the conductive adhesive. As a result, the conductive paste allows printing of the sensing line and selection of an appropriate (e.g., relatively easily tearable) substrate for the sensing line while allowing use of an optimal substrate for manufacturing and/or protecting the antenna and the integrated circuit.

In addition, the loop may include two parts, rather than one contiguous part. For example, the substrate may have a non-contiguous loop which is only completed (i.e., electrical contact is formed) after a metal foil or conductive (e.g., metal) shrink wrap is placed on the cap (e.g., a metal cap).

The present substrate (e.g., label) may be advantageously combined with tamper evident adhesives and/or paper for an extra layer of security. In such embodiments, the consumer, retailer, distributor, or brand representative will also have a visual indication of tampering with the bottle and/or the substrate.

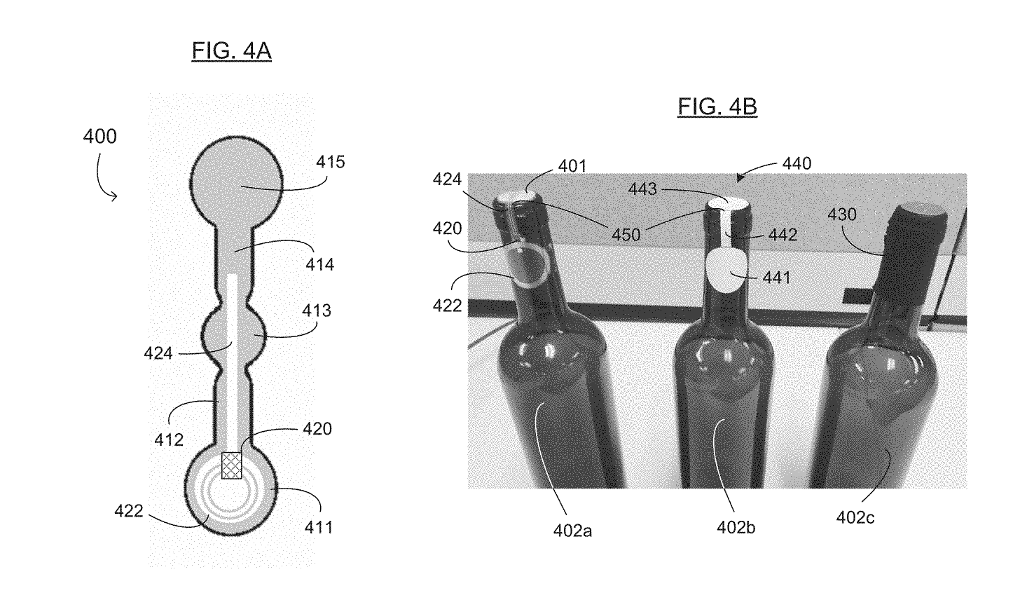

FIG. 4A shows another exemplary substrate 400 (a variation of the substrates of FIGS. 2 and 3A-C) having an exemplary wireless communication device thereon. The wireless communication device includes an antenna 422 and an integrated circuit 420 on a first part 411 of the substrate 400. In addition, the wireless communication device includes a sensing line 424 on a second part of the substrate 411. In some embodiments, the third part 413 of the substrate 400 is placed on an uppermost surface of a sealing device or mechanism. In alternative embodiments, the third part 413 of the substrate 400 may include the antenna 422 and the integrated circuit 420. Fourth and fifth parts 414 and 415 of substrates 400 may be on an opposite side of the bottle and the sealing device or mechanism from the first and second parts 411 and 412.

FIG. 4B shows exemplary bottles 402a-c with the substrate 400 of FIG. 4A placed thereon, and a label 400 or capsule 430 thereover, in accordance with one or more embodiments of the present invention. More specifically, the bottles 402a-c may include a wine bottle having a long neck. Generally, the wine bottles have a non-metallic seal, such as a cork 401 as the sealing device, and a non-metallic shrink wrap thereover. In various embodiments, the label 440 may comprise a pressure-sensitive label that includes or consists of paper and an inlay construction. The pressure-sensitive label can be compatible with glass or plastic, depending on the material of the bottles 402a-c.

As shown on the left bottle 402a, a pressure-sensitive and transparent substrate (e.g., substrate 400) may be placed over the sealing device or mechanism (e.g., cork 401). For example, the third part 413 of the substrate 400 is adhered to a top or uppermost surface of the cork 401. The second and fourth parts 412 and 414 of the substrate 400 that includes the sensing line 424 may be placed on the neck of the bottle 402 and over the break line 450.

The first part 411 of the substrate 400 having the antenna 422 and integrated circuit 420 thereon are placed on the neck of the bottle 402a, as is the first part 415 of the substrate 400 (but on the opposite side of the bottle 402 from the first part 411).

After placement of the substrate 400, a label 440 is placed over the substrate 400 including the wireless communication device, as shown on the middle bottle 402b. The label 440 may have portions 441, 442 and 443 over corresponding portions of the substrate 400 on bottle 402a.

As shown on the right bottle 402c, a shrink wrap, sleeve or capsule 430 may be formed on or over the substrate 400 and the label. In one example, a spinner may secure the shrink wrap, sleeve and/or capsule to the bottle. In exemplary embodiments of the present invention, the shrink wrap may include one or more materials such as paper, plastic, a metal foil, or a combination or laminate thereof. Additionally, an adhesive may be applied to the shrink wrap prior to its placement over the substrate 400 and label 440 for added security.

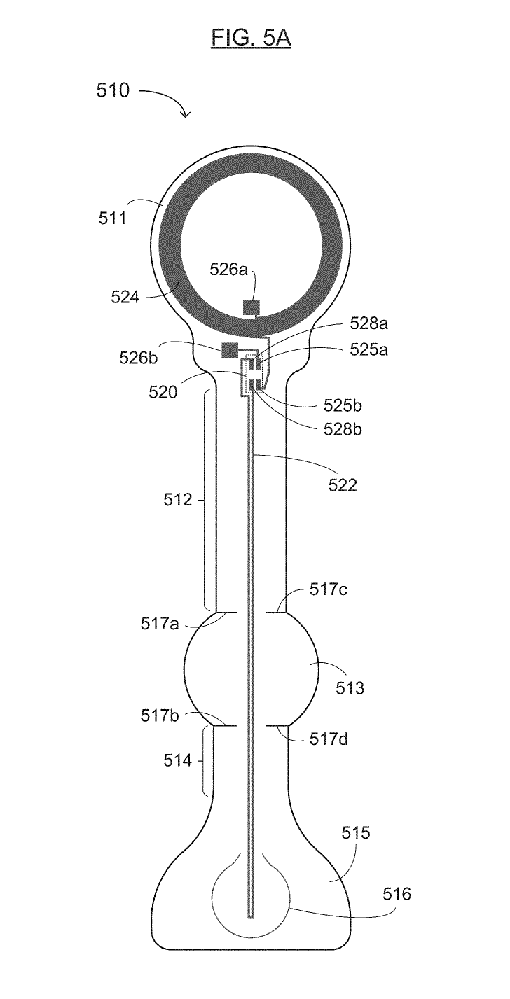

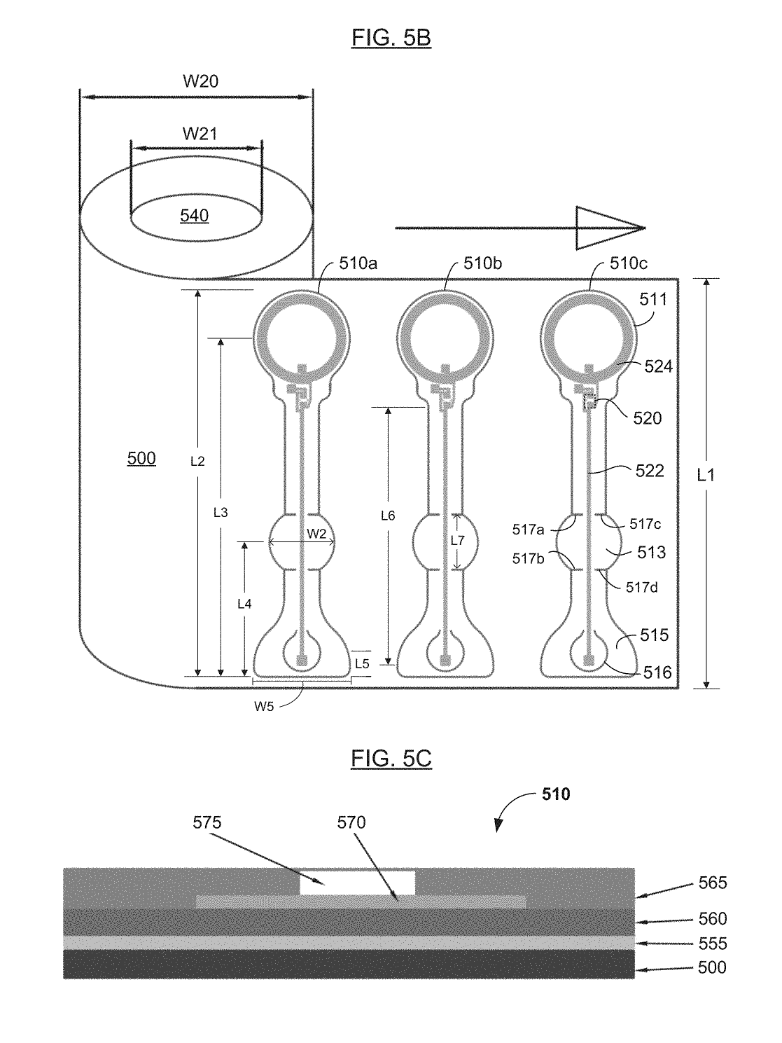

FIG. 5A shows an exemplary label 510 having a wireless communication device thereon and having cuts or perforations 517a-d therein, in accordance with one or more embodiments of the present invention. The label 510 may be on a substrate such as a strip or sheet of carrier web. The may have a first part 511, a second part 513, and a third part 515. In addition, the label 510 may have straight parts 512 and 514. The label 510 may have a substantially straight shape with curved ends, as shown in FIG. 5A. Alternatively, the label 510 may have a tapered or substantially completely rounded shape (e.g., a bowtie or hourglass shape).

The first part 511, which is configured to be placed on the neck, shoulder and/or body of the bottle, may include the antenna 524 and integrated circuit (not shown, but the area of which is indicated by the identifier 520) thereon. In addition, the first part 511 may include antenna pads 525a-b and connection pads 526a-b over holes or vias in the label 510. The holes or vias under the connection pads 526a-b are configured to connect the inner terminal of the antenna 524 to a bond pad 525a of the integrated circuit 520 using a trace line (not shown). Generally, the pads 525a-b and 526a-b are formed on the same surface of the label 510 as the integrated circuitry 520, and the trace line (ends of which are on or over the holes or vias) is formed on the opposite surface of the label 510.

In various embodiments, the first part 511 and the second part 513 of the label 510 may be joined or connected by a first straight part 512. The first straight part 512 generally is on the neck and optionally on the shoulder of the bottle, and if on the shoulder, the portion of the first straight part 512 closest or in proximity to the first part 511 may be on the body of the bottle. The first straight part 512 primarily supports a first part of the sensing line 522 (which is connected electrically to the integrated circuit through bond pads 528a-b).

In an exemplary embodiment, the second part 513 may have a curved shape, as shown in FIG. 5A. However, the second part 513 may have any of various other shapes, such as oval, square, rectangular, triangular, pentagonal, hexagonal, irregular or tapered (or a combination thereof), but the shape of the second part 513 is not limited thereto. The second part 513, which is configured to be placed on the sealing device or mechanism (e.g., a cork) and optionally over the break line, generally includes the sensing line 522 over at least one and preferably both interfaces (i.e., with the first straight part 512 and/or a second straight part 514).

In various embodiments, the second straight part 514 also supports the sensing line 522. Generally, the second straight part 514 is on a neck of the bottle opposite from the first straight part 512. The third part 515 may be rounded or have (but not be limited to) a curved or tapered shape. In exemplary embodiments, the third part 515 may have a substantially triangular shape having curved or round edges or lines (e.g., a flat-bottom teardrop shape), as shown in FIG. 5A. In addition, the third part 515 may be placed on and/or adhered to the neck, shoulder and/or body of the bottle. Furthermore, the third part 515 may include a cut-out or notched portion 516 in or substantially near a center of the third part 515. In exemplary embodiments, the cut-out 516 has the sensing line thereon and is configured to provide an additional tamper resistance mechanism. In one exemplary embodiment, the cut-out 516 protects the sensing line 522 from inadvertent severing when the third part 515 is damaged (e.g., by peeling a corner of the third part 515 prior to sale and/or use by a bona fide purchaser. As a result, the third part 515 of the label 510 may include part of the sensing line 522. Alternatively, the third part 515 may include the antenna 524 and integrated circuit 520, and the first part 511 may include the sensing line 522 and optionally the cut-out 516.

In various embodiments, the second part 513 of the label 510 may include a plurality of slits, notches, scores, and/or perforations 517a-d. The slits, notches, scores, and/or perforations 517a-d are configured to facilitate breaking, tearing, or severing the label 510 and the sensing line 522 thereon.

Referring to FIG. 5B, the carrier web (e.g., a roll or sheet of labeling material) 500 may have a length or width L1 from about 50 to 300 mm (e.g., from 60 to 200 mm, or any length or widths or range of lengths or widths therein). In various examples, L1 is from about 145 mm to about 170 mm. The length or distance L2 from an outermost edge of the first part 511 to an outermost edge of the third part 515 of the labels 510a-c may be from about 50 to 300 (e.g., from 60 to 200 mm, or any length or range of lengths therein). In one example, L2 is about 136 mm. In addition, the length or distance L3 from a center of the first part 511 of the labels 510a-c including the antenna 524 and integrated circuit 520 to the outermost edge of the third part 515 of the labels 510a-c may be from about 45 to 270 mm (e.g., from 50 to 180 mm, or any length or range of lengths therein). In one example, L3 is about 120 mm. Furthermore, a length or distance L4 from the center of the second part 513 of the labels 510a-c to the outermost edge of the third part 515 of the labels 510a-c may be about from about 25 to about 150 mm (e.g., from 30 to 100 mm, or any length or range of lengths therein). In some examples, L4 is less than of L3. The length or distance L5 from a center of the third part 515 to the edge of the third part 515 of the labels 510a-c may be from about 3 to 50 (e.g., from 6 to 25 mm, or any length or range of lengths therein). In one example, L5 is about 8.5 mm. Furthermore, the width W5 at an end of the third part 515 of the labels 510a-c may be from about 5 to 100 mm (e.g., from 10 to 50 mm, or any length or range of lengths therein). In one example, W5 is about 34 mm.

Typically, a diameter of the antenna 524 may be from about 1 to 100 mm (e.g., from 5 to 50 mm, or any length or range of lengths therein), and the antenna 524 may have from 4 to 50 loops or “rings” in the spiral. In one example, the diameter of the antenna 524 is 31 mm. A square, rectangular, oval or other-shaped antenna may have dimensions and a number of loops or rings providing a similar or identical length of the antenna wire. Generally, a width of the sensing line 522 may be from about 0.01 to 0.50 mm (e.g., from 0.1 to 0.3 mm, or any width or range of widths therein). The gap between the outgoing and returning sections of the sensing line 522 may be 0.01 to 5 mm. Length L6 of the sensing line 522 may be from 30 to 200 mm (e.g., 45 to 150 mm, or any length or range of lengths therein). In one example, L6 is about 80 mm.

The labels 510a-c may have a length or distance from the center of the first part 511 to a first slit, notch, score, or perforation 517a or 517c of about 5 to 150 mm (e.g., from 20 to 100 mm, or any length/distance or range of lengths/distances therein). In one example, the length is of about 63 mm. Alternatively, the length is about 42 mm. The length or distance L7 between first and second slits, notches, scores, or perforations 517a and 517b and/or 517c and 517d may be from about 1 to 50 mm (e.g., from 5 to 20 mm, or any length/distance or range of lengths/distances therein). In one example, L7 is about 10 mm. Alternatively, L7 is about 9 mm. Generally, the slits, scores, or perforations 517a-d may have a length of about 1 to 25 mm (e.g., from about 1.5 to 10 mm or any value or range of values therein). In one example, this length is about 2 mm. To avoid accidently breaking the sensing line during production, the score, cut, slit, or perforation 517a-d may be kept well-separated from the sensing line 522 (e.g., spaced apart by at least one, two, or more mm).

As shown in FIG. 5A, a distance or spacing between the antenna 524 and an outermost peripheral edge of the first part 511 of the label 500 may be from about 1 to 25 mm (e.g., from about 2 to 10 mm or any value or range of values therein). For example, this spacing may be from is about 1.0 mm to about 4 mm. In one example, the spacing is about 1.5 mm. In addition, a radius or distance from the periphery of the cut-out 516 in the third part 515 of the label 500 to the center of the third part 515 may be about 2 to 20 mm (e.g., from about 2 to 10 mm or any value or range of values therein). In one example, the radius or distance is about 4 mm. Furthermore, a distance or spacing from the center of the first part 511 of the label 500 to an outermost edge of the integrated circuit area 520 may be from 10 to 50 mm (e.g., 15 to 30 mm or any value or range of values therein). In one example, it is about 20 mm.

The first part 511 and the fifth part 515 of the labels 500 may independently have diameter or width of about 10 to 100 mm (e.g., from about 20 to 50 mm or any value or range of values therein). In various examples, this width or diameter is about 30 mm to about 40 mm. The second part 513 of the label 510 may have a diameter W2 of about 10 to 100 mm (e.g., from about 15 to 50 mm or any value or range of values therein). In one example, D2 is about 20 mm to 30 mm. Furthermore, adjacent labels may be spaced apart from each other at a distance S1 of about 1 to 50 mm (e.g., from about 2 to 25 mm or any value or range of values therein). In various examples, S1 is about 4 mm to about 17 mm.

FIG. 5B shows labels 510a-c on a roll or sheet of carrier web 500 used for roll-to-roll processing. The carrier web 500 may be on a roll or spool 540 and may have an outer width or diameter W20 of 100 mm to 300 mm. The roll or spool 540 itself may have a width W21 of 50 mm to 200 mm. In one example, a maximum value of W20 is 300 mm, and a maximum value of W21 is about 150 mm.

FIG. 5C shows a cross-sectional view of the label 510 having a wireless communication device thereon in accordance with one or more embodiments of the present invention. The label 510 is formed on a roll or sheet 500 that generally includes a polyimide, polymer laminate, high temperature polymer, metal foil and/or paper. An adhesive layer (e.g., a hot melt adhesive) 555 is coated or deposited on the roll or sheet 500 (e.g., by extrusion coating or printing). Subsequently, an inlay material 560 (e.g., polyethylene terephthalate [PET]) for formation of the “smart label” is deposited or coated (e.g., by printing, extrusion coating, or roll-to-roll processing) on the adhesive layer 555. Next, a layer 570 of aluminum or other conductor is deposited on the inlay 560 (e.g., by printing, evaporation, sputtering, spin-coating, etc.). The layer 570 may form the antenna 524, sensing line 522, and pads for the integrated circuit. An integrated circuit (IC) 575 is formed (e.g., by printing a plurality of layers in predefined patterns) on the aluminum layer 570. An electro-static discharge, electrostatic dissipative or antistatic film (e.g., a Kinsky ESD film) 565 is then deposited on or over the inlay 560, the aluminum layer 570 and the integrated circuit 575.

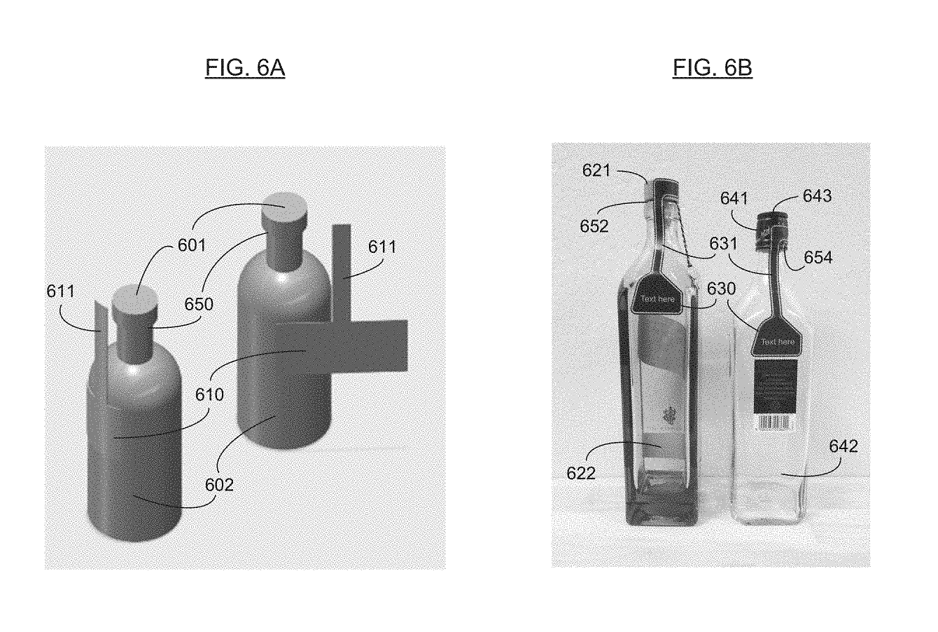

FIGS. 6A-B show exemplary bottles 602, 622, and 642 having a substrate (e.g., a “face-and-tail” label) thereon in accordance with one or more embodiments of the present invention. The substrates may be placed on the bottle 602, 622, and 642 using the bottle labeling machine of FIG. 1, as discussed above, or a similar conventional bottle labeling machine. In exemplary embodiments, the substrate includes a label. The label (e.g., 630/631 in FIG. 6B) may comprise or consist of a paper face having an inlay (e.g., a plastic inlay) that makes the second part 630 of the substrate (e.g., a tail portion of the label) 610 relatively stiff or rigid in comparison with the first part 630 of the label, thereby, providing a more controlled application of the label to the bottle 622 or 642.

FIG. 6A shows an exemplary bottle 602 having a substrate (e.g., a pressure-sensitive, “face-and-tail” label) with a wireless communication device thereon. As shown in FIG. 6A, a first part 610 of the substrate including the antenna and integrated circuit thereon is on or over and wrapped around the body of the bottle 602 and/or over the shoulder and neck of the bottle. For example, the first part 610 of the substrate is first attached or applied to the body, and then a second part 611 of the substrate 610 including the sensing (sense) line is adhered or applied to the shoulder and neck of the bottle 602, and a side surface of the sealing device or mechanism 601. As a result, the second part 611 of the substrate 610 is on or over a break line 650 between the bottle 602 and the cap or other sealing mechanism 601. Alternatively, the sensing line(s) may be on a second, separate substrate (not shown) from the substrate 610 having the antenna and the integrated circuit thereon. The second substrate having the sensing line(s) thereon may be placed on or over the substrate 610, such that the sensing line electrically connects to the integrated circuit and is over the break line 650.

FIG. 6B shows exemplary bottles 622 and 642 having a substrate including a wireless communication device thereon. As shown in FIG. 6B, a first part 630 of the substrate 610 (e.g., a variation of the pressure-sensitive “face-and-tail” label) including the antenna and integrated circuit is on a shoulder and body of the bottles 622 and 642, and a second part of the substrate 631 including a sensing (sense) line is on the shoulder, over a break line 652 or 654, and on a side surface of the sealing device or mechanism (e.g., a cap) 621 or 641. As shown in FIGS. 6A-B, majority of the first part 630 of the substrate 610 (including the portion with the antenna therein) may be on the body of the bottles 622 and 642.

As shown in FIG. 6B, the second part 631 of the substrate including the sensing (sense) line may wrap around the side surface of the sealing device or mechanism 621 or capsule 641. A region (e.g., a “flag” portion) of the second part 631 of the substrate that wraps around the sealing device advantageously provides an increased or extended area for adhesive contact to the sealing device or mechanism 621 or capsule 641, as well as for contact with a purchaser's or user's hand (e.g., to increase the probability that the sensing line will break upon removal of the sealing device or mechanism 621 or 643). In exemplary embodiments, the second part 631 of the substrate wraps around the sealing device or mechanism 621 or capsule 641 and covers about at least a 50° arc. For example, the second part 631 of the substrate may wrap around an arc of from 50 to 300°, 90-180°, or any other arc or range of arcs of the sealing device or mechanism 621 or capsule 641. In one example, the second part 631 of the substrate covers about a 120° arc along the side surface of the sealing device or mechanism 621 or capsule 641. A coverage of 90-180° is advantageous when the label is applied by moving the bottle linearly and applying the label perpendicular to the axis of the neck. However, applying the label as the bottle turns (e.g., adhering the lead edge of the label first and subsequently feeding the label as the bottle spins, for example in a wrap, merge or match speed application) enables coverage of more than 180°, which allows the label to securely adhere or grip to the bottle. In some embodiments, the second part 631 of the substrate may wrap entirely around the sealing mechanism, and may cover an arc of >360° (e.g., a 390-450° arc). Wrapping the second part 631 of the substrate entirely around the sealing mechanism allows greater variability in the label length and the bottle diameter, and secures the substrate to the bottle more effectively.

Additionally, as shown in the bottle 642 in FIG. 6B, a capsule and/or shrink wrap 641 may be on or over the sealing device or mechanism 643. The shrink wrap or capsule 641 may also be on or over part of the second part 631 of the substrate and an uppermost part (i.e., the neck) of the bottle 642. When the shrink wrap 641 is placed over the bottle 642, the shrink wrap 641 may be applied as a folded web (e.g., a flat web that is folded over from one side along the axis of the film feed, in which an adhesive is applied to the top side of the fold, the other side of the web is folded to the middle of the film, and adhesive is applied along the axis of the film feed such that it overlaps the first folded edge), and bonds to itself. Alternatively, the shrink wrap 641 may be applied at the packaging line. It may be in the form of a label, and be wrapped about the long axis of the bottle 642 over the sealing mechanism and adhered to itself after it is wrapped more than 360° around the bottle 642. Thereafter, the shrink wrap 641 is exposed to heat and/or such that it conforms to the contour of the bottle 642. The sensing line (e.g., on the “tail” or second part 631 of the substrate) may have a continuity loop (e.g., sensing line) going up the neck of the bottle and onto the sealing device or mechanism (e.g., cap). Thus, in the case where a shrink wrap 641 is under or over a part of the smart label having a sensing line thereon, it relatively difficult to remove the shrink wrap 641 without breaking the sensing line.

Additionally, a pull-tab on the first part 630 may be used for retailers to indicate a sale of the product in the bottle and/or for customers to participate in various games. A second sensing line electrically connected to a second continuity sensor in the integrated circuit may cross the interface between the portion of the substrate on which the integrated circuit is located and the pull-tab. By playing the game, the second sensing line is severed, and there may a communication and/or recording to the effect that a customer has purchased a bottle. Until the tab is pulled, the tab broadcasts its primary key (e.g., indicating that the product in the bottle is unpurchased). In this example, because a sensing line crosses the edge of the pull-tab, once the tab is pulled, the second continuity sensor changes state, and the tag (e.g., antenna and integrated circuit) no longer broadcasts the primary key.

Instead, the tag broadcasts a secondary key (e.g., indicating that the product in the bottle has been purchased). The secondary key advantageously indicates that the product in the bottle has been sold, thus minimizing the chance of bottles being refilled illegally.

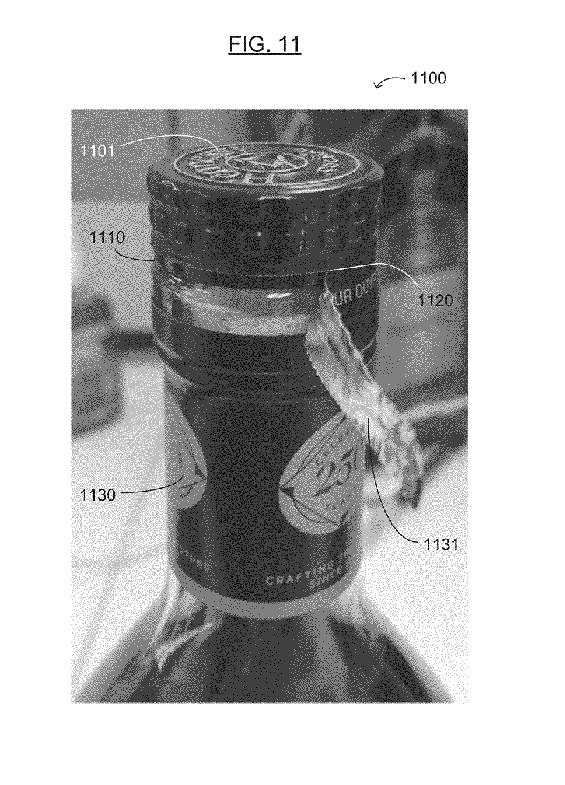

Typically, the open detection loop (e.g., sense line) is bonded to the shrink wrap or capsule 641 and along the side surface of the caps 621 and 643. The continuity sensor in the integrated circuit is on the shoulder of the bottles 622 and 642. In an alternative embodiment, the continuity sensor is on over the top of the caps 621 and 643. Shrink wrap 641 may have a set of weak points therein because the shrink wrap or capsule is a continuous tube of material. For example, a cut-stripe (see, e.g., FIG. 11) may be placed across the shrink wrap or capsule just below the cap 643. A continuity loop (e.g., the sensing line) extends along a cylindrical surface of the shrink wrap or capsule 641, to the cap 641. The tag (i.e., antenna and integrated circuit) is or below the bottom end of the cylindrical surface of the shrink wrap or capsule 641, where the shrink wrap or capsule 641 shrinks around the neck of the bottle. Then, when the bottle 642 is opened, the twist of the cap 643 will break the sensing line. Shrinking is already integrated into most bottling or bottled products manufacturing lines, and as a result, there is minimal or no new equipment or re-tooling needed to incorporate the present substrate/label into production.

In some embodiments, the shrink wrap may be on or over the bottle, and the substrate is on or over the shrink wrap. However, issues may arise when there is nothing adhering the shrink wrap to the bottle, and the shrink wrap having the substrate thereon is removed. In such embodiments, the entire shrink wrap may be removed from the bottle, along with part or all of the antenna. To ensure that the entire tag, but not all of the sense loop, remains with the bottle, a heat-activated, pressure-sensitive adhesive may be used on or over the substrate or the shrink wrap at a predetermined locations. Also, when the shrink wrap is turned, but not removed, the entire shrink wrap may rotate around the bottle, breaking the sensing line and indicating that the bottle has been opened, when in fact the bottle may not be opened at all. To ensure that the shrink wrap does not rotate, the shrink wrap can be adhered to the bottle using such a heat-activated, pressure-sensitive adhesive. The temperature at which the adhesive becomes sticky can be controlled. Thus, the shrink wrap may be on or over the bottle, and the substrate may be on or over the substrate (or vice versa, as explained above).

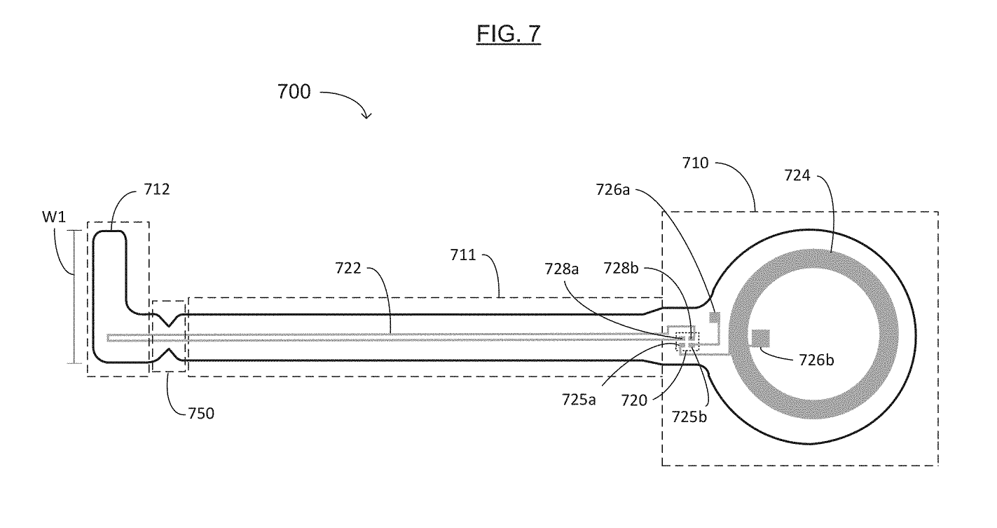

FIG. 7 shows an exemplary wireless communication device on a substrate (or label) 700 in accordance with one or more embodiments of the present invention. In various embodiments, the wireless communication device includes an antenna 724 in a first part 710 of the substrate 700 and a sensing line 722 in second and third parts 711 and 712 of the substrate 700. In addition, the wireless communication device includes an integrated circuit (not shown, but to be located in area 720) in the first part 710 of the substrate 700. The integrated circuit 720 may comprise or consist of a printed integrated circuit.

In addition, the first part 710 may include antenna pads 725a-b for connecting the antenna 724 to the integrated circuit, and connection pads 726a-b over holes or vias in the substrate 700. The holes or vias under the connection pads 726a-b are configured to enable a trace line (not shown) to connect the inner terminal of the antenna 724 to the integrated circuit. Generally, the pads 725a-b and 726a-b are formed on the same surface of the substrate 700 as the integrated circuitry 720, and the trace line is formed on the opposite surface of the substrate 700. The second part 711, which is straight or substantially straight, primarily supports a majority of the sensing line 722 (which connects electrically to the integrated circuit through bond pads 728a-b).

In some embodiments, an interface between the second and third parts 711 and 712 of the substrate 700 may include a break zone 750. As shown in FIG. 7, the break zone 750 may be substantially thinner (or include a substantially thinner portion) than the rest of the second part 711 of the substrate, and the spacing between traces in the sensing line 722 may be less than that in the remainder of the second part 711 of the substrate. The third part 712 may include the sensing line 722. The third part 712 of the substrate may have an L-shape, configured to provide additional surface area or bulk to this part of the substrate 700. Providing the third part 712 with additional surface area or bulk advantageously increases adhesion of the substrate to the bottle and/or the cap or other sealing mechanism. Also, the additional surface area of the third part 712 may prevent the substrate (e.g., label) from becoming loose and/or peeled off without breaking the sensing line 722, enabling the user to remove the cap or other sealing mechanism from the bottle while the label incorrectly indicates a “sealed” state for the bottle.

The antenna 724 may be printed (e.g., using a printed conductor such as, but not limited to, silver from a silver paste or ink) or manufactured using conventional methods like blanket metal deposition and etching (e.g., by sputtering or evaporating aluminum on the substrate [such as a plastic film or sheet], patterning by low-resolution [e.g., 10-1,000 μm line width] photolithography, and wet or dry etching). Some or all portions of the sensing line(s) 722 may be patterned on the opposite side of the substrate material from the antenna coil, in order to electrically isolate them from each other. The antenna 724 may be sized and shaped to match any of multiple form factors, while preserving compatibility with reader hardware (e.g., the NFC 13.56 MHz target frequency).

When a dry inlay (e.g., where no adhesive is on the substrate) is converted to a wet inlay (e.g., where adhesive is on the substrate), a process margin or tolerance in the break zone 750 may allow for a cut, notch, score, or perforation to be made before, during or after such conversion without cutting into the sensing line 722. When a relatively narrow “tail” (e.g., the third part 712 of the substrate or a second, separate substrate) is to be placed onto the neck of a bottle, the width and/or spacing of the sensing line(s) 722 may be reduced to those of the minimum design rules. When printing the sensing line(s) and/or processing the sensing line(s) and/or substrate by roll-to-roll processing, an additional tolerance (e.g., a conversion tolerance) may be applied to a region of the sensing line(s) 722 (e.g., in the break zone 750).

In the backend of the “smart label” manufacturing process flow, in which insertion or placement of a printed integrated circuit (or an integrated circuit or other component in a hybrid process) occurs as a last step, there may be difficulty in aligning two die cuts (particularly in a perforation, notch, or slice in the substrate having the integrated circuit, printed integrated circuit, or other component thereon). A notch in the break zone 750 may be made by cutting along the peripheral edges of the wet label. Before or after applying adhesive, a perforation in labels including graphics thereon may allow for some misalignment. If such misalignment is within a few millimeters, the perforations (e.g., notches) may still be sufficiently aligned to enable tearing of the substrates along all of the perforations (or notches) at the same time. In another embodiment, layers of the label-containing substrates other than the top, graphic-containing layer may be perforated, thereby offering a covert security element while also facilitating tearing of the sensing line at an appropriate time.

Using minimum design rules along an entire length of the sensing (sense) line 722 may result in inadvertent shorting or other defects. However, the width and/or spacing between sections or traces of the sensing line 722 (as well as the likelihood of potential shorting and other defects) may be reduced by having one side or trace of the sensing line 722 on a front side of the substrate 700, a via at the end of the second part 711 or the third part 712 of the substrate 700 opposite from the first part 710, and a return trace of the sensing line 722 on a back side of the substrate 700 to reconnect the sensing line 722 back at the integrated circuit 720. When both ends of the sensing line 722 are connected to the integrated circuit 720, a second via may be formed in the substrate (e.g., in the vicinity of the integrated circuit 720). As a result, the present invention advantageously provides a commercially acceptable narrow “tail” to accommodate certain bottle shapes that may require a narrow tail.

The dimensions of the structures on the substrate 700 may include, for example, a length from a center of the third part 712 to the center of the first part 710 of from about 50 to 300 mm (e.g., from 60 to 200 mm, or any length or range of lengths therein). In one example, this length is about 105 mm. In another example, it is about 111 mm. A length from the center of the first part 710 to about a center of the break zone 750 may be from about 40 to 250 mm (e.g., from 50 to 150 mm, or any length or range of lengths therein). In one example, this length is about 92.5 mm. In another, this length is about 105 mm. In addition, a length of the second part 711 may be from about 5 to 150 mm (e.g., from 10 to 100 mm, or any length or range of lengths therein). In one example, this length is about 90 mm. The sensing line 711 may have a length and/or width similar to or the same as that of the embodiment in FIGS. 5A-B. The break zone 750 may have a length or width perpendicular to the sensing line 722 at its widest point of from about 1 to 50 mm (e.g., from 2 to 25 mm, or any width or range of widths therein). In one example, the length or width is about 2.75 mm. In addition, the break zone 750 may have a length or width parallel with the sensing line 722 at its shortest point of from about 0.1 to 50 mm (e.g., from 0.5 to 25 mm, or any length or width or range of lengths or widths therein), and at its widest part of about 1 to 10 mm (e.g., 1-5 mm or any length or range of lengths therein). In one example, the length or width is about 2 mm. A width W1 of the third part 712 of the substrate 700 may be from about 15 mm to about 100 mm (e.g., from 20 mm to 50 mm, or any width or range of widths therein). In one example, the width W1 is about 21.5 mm, and about 25 mm in another example. Furthermore, the antenna 724 may have a round peripheral edge with a radius of from about ⅙th to less than ½ of the width of the first part 710 of the substrate 700.

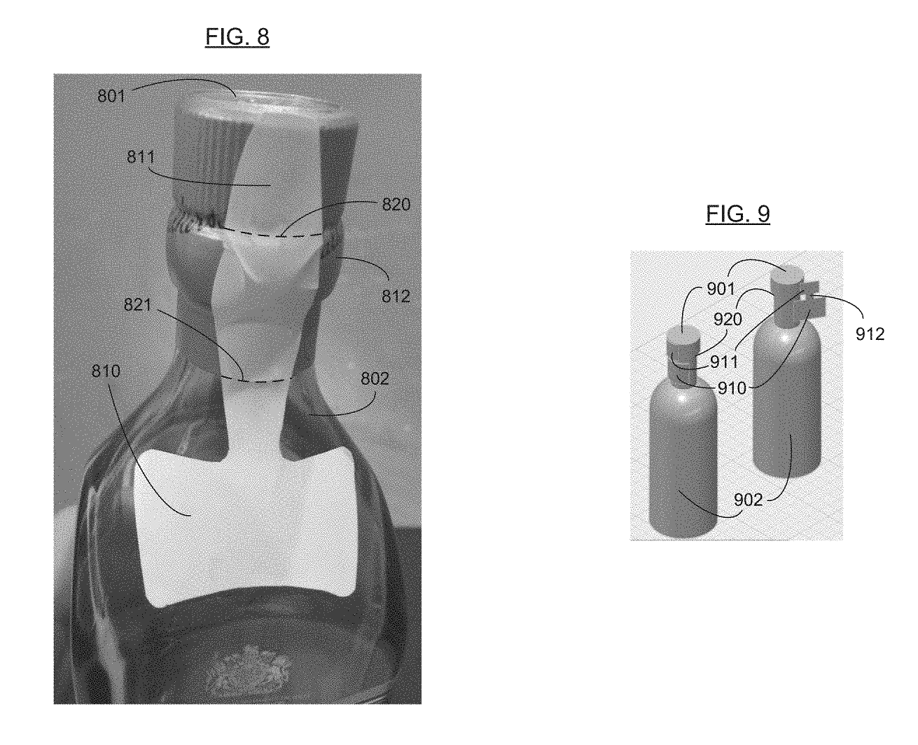

FIG. 8 shows an exemplary bottle 802 having a substrate (e.g., a hammer-type label, similar to the label of FIGS. 6A and 7, but with a relatively short tail) thereon, in which one or more sensing lines may be on or over multiple break lines 820 and 821 in accordance with one or more embodiments of the present invention. The substrate of FIG. 8 may also be suitable for angled or curved surfaces. As shown in FIG. 8, a first part 810 of the substrate (e.g., a pressure-sensitive label) may include an antenna and an integrated circuit, and may be on the body and/or the shoulder of the bottle 802. In exemplary embodiment, a second part 811 of the substrate may include the sensing (sense) line, and may be on or over the shoulder and/or neck of the bottle, the break lines 820 and 821, and a side surface of the sealing device or mechanism 801. A shrink wrap or capsule 812 may be formed on or over the substrate 811. In one example, a spinner secures the shrink wrap or capsule 812 to the bottle. In exemplary embodiments, the shrink wrap may include one or more materials such as paper, plastic, a metal foil, or a combination or laminate thereof. Additionally, an adhesive may be applied to the shrink wrap or sleeve prior to its placement on the bottle 802 for added security.

The hammer-type substrate may have a shape somewhat or completely following a contour of the bottle 802. For example, the substrates may be narrow in relatively narrow parts of the bottle 802 (e.g., to avoid creating a bubble under the substrate), and may be relatively wide where the surface area of the bottle 802 increases. When the substrate has a shape at least somewhat following the contour of the bottle 802, adhesion between the substrate and the bottle 802 generally increases. A variety of shapes for the substrates can be used so that the label can follow the contour of the surface of the bottle 802. For example, labels may be narrow (in part or in whole) to optimize bending, but the width may be increased to provide a more stiff or rigid substrate and allow the second part of the substrate to be applied using conventional bottle labeling equipment. As a result, the substrate can be made more stable and can be easily applied to the bottle. Additionally, structural elements such as an increase in the width of a neck or second portion of the label may be added to the substrate to increase the sturdiness and/or bendability of the substrate. Such added elements may be beneficial or necessary to apply when using rotary bottle handling, conveyors, or star wheels. Alternatively, linear transporting may be used for transporting the bottles.

FIG. 9 shows an exemplary bottle 902 with an alternative substrate (e.g., a “cap wrap”-type substrate) thereon, in which the substrate wraps around both the bottle 902 and the sealing device or mechanism 901 accordance with one or more embodiments of the present invention. As shown in FIG. 9, a part 912 of the substrate including a sensing line (not shown) may be on a side surface of the cap 901, on or over the neck of the bottle 902, and on or over a break line 920. In various embodiments, the substrate may be a pressure-sensitive label and/or comprise or consist of a two-layer construction, including paper and inlay. In exemplary embodiments, a part 911 of the substrate including the antenna and integrated circuit may be on the side surface of the sealing device or mechanism 901. As shown in FIG. 9, a part 910 of the substrate including graphics is on the bottle 902, and may include the sensing line thereon. The part 910 may have a substantially greater area than the part 911. In an alternative embodiment, the antenna and integrated circuit may be on the part 910, and the sensing line may be on the part 911.

As is shown in FIG. 9, the part 912 of the substrate has the smallest width. The part 911 may have a width relatively greater than the part 912, but relatively less than the part 910. In one example, the part 910 is 1.5-2 times wider than the part 911, and the part 911 is about two times wider than the part 912 but the parts 910-912 are not limited to such proportions. Also, the part 912 of the substrate has a relatively small height compared to other embodiments (e.g., as shown in FIGS. 2-8). The part 911 may have a height about the same as or greater than the part 912, but less than the part 910. In one example, the height of the part 910 is about two times greater than that of the part 911, and the height of the part 911 is about 1.5-2 times greater than that of the part 912.

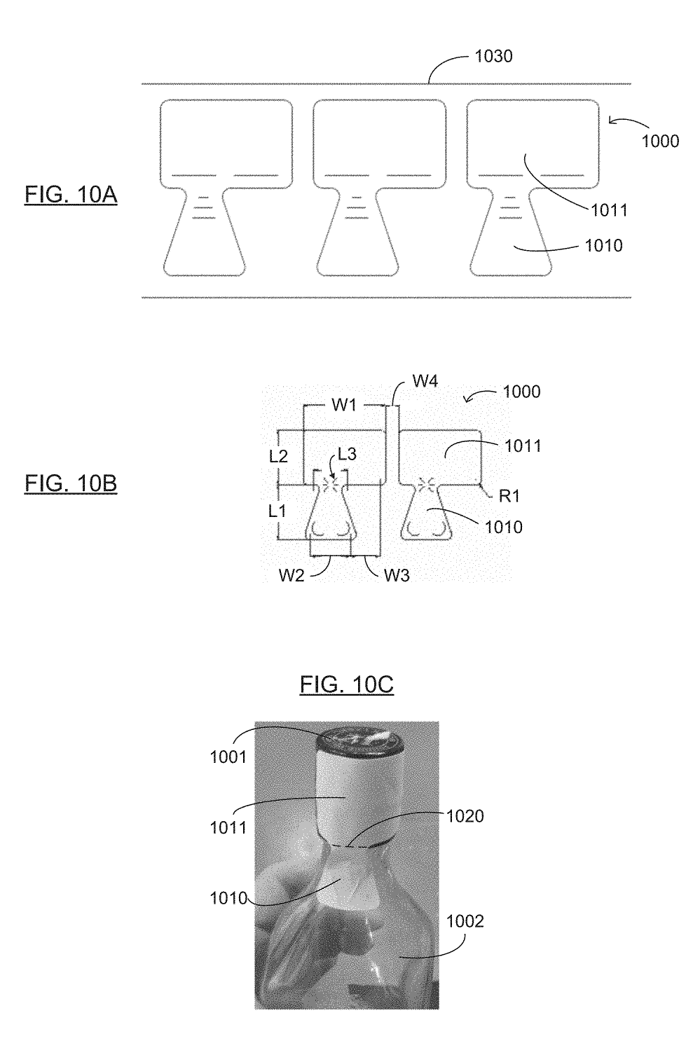

FIGS. 10A-B show a further alternative substrate 1000 on a sheet or roll 1030 of the carrier web, and FIG. 10C shows an exemplary bottle 1002 with the alternative substrate 1000 of FIGS. 10A-B thereon. As shown in FIG. 10A, one part 1010 of the substrate 100may be substantially smaller than another part 1011 of the substrate. In some embodiments, the antenna and integrated circuit may be on the smaller part 1010 of the substrate, and the sensing line may be on the larger part 1011 of the substrate. Alternatively, the antenna and integrated circuit may be on the larger part 1011 of the substrate, and the sensing line may be on the smaller part 1010 of the substrate.

FIG. 10B shows exemplary dimensions of the substrate 1000 of FIG. 10A. For example, a length or height L1 of the lower part 1010 of the substrate may be from about 5 to 200 mm (e.g., from 10 to 100 mm, or any length or range of lengths therein). In one example, L1 is about 30 mm. In some embodiments, a length or height L2 of the upper part 1011 of the substrate may be from about 5 to 200 mm (e.g., from 10 to 100 mm, or any length or range of lengths therein). In one example, L2 is the same as L1 (e.g., about 30 mm). In various embodiments, the length or width L3 of the interface between the lower and upper parts 1010 and 1011 of the substrate may be from about 1 to 50 mm (e.g., from 2 to 20 mm, or any length or range of lengths therein). In one example, L3 is about 3 mm.

In addition, the upper part 1011 of the substrate may have a width W1 of from about 5 to 200 mm (e.g., from 10 to 100 mm, or any width or range of widths therein). In one example, W1 is about 45 mm. The width W2 of the lower part 1010 of the substrate may be from about 5 to 150 mm (e.g., from 10 to 75 mm, or any width or range of widths therein). In one example, W2 is about 21 mm. The width or spacing W3 from an outermost edge of the lower part 1010 of the substrate to an outermost edge of the upper part 1011 of the substrate may be from 0 to about 100 mm (e.g., from 5 to 50 mm, or any width or range of widths therein). In one example, W3 is about 16 mm. Adjacent substrates 1000 on a sheet of label material 1030 (FIG. 10A) may be spaced apart by a distance W4 of from about 1 to 100 mm (e.g., from 3 to 50 mm, or any distance or range of distances therein). In one example, W4 is about 7.5 mm.

Furthermore, each of the lower part 1010 and the upper part 1011 of the substrate may have plurality of corners. A radius R1 of each corner of the lower and upper parts 1010 and 1011 of the substrate may independently be from about 0.5 to 50 mm (e.g., from 1.5 to 20 mm, or any radius or range of radii therein). In one example, R1 is about 4 mm.

FIG. 10C shows an exemplary bottle 1002 having the alternative substrate 1000 (e.g., a cap label) thereon. The substrate 1000 may be a pressure-sensitive label having a two-layer construction including paper and inlay. As shown in FIG. 10C, the upper part 1011 of the substrate (which may include the antenna and the integrated circuit) may be on and may wrap around the sealing device or mechanism (e.g., a cap) 1001. The cap 1001 may be or comprise a metal cap. In exemplary embodiments, the upper part 1011 of the substrate covers about at least a 50° arc (e.g., 50-300° or a 90-180° arc, or any value or range of values therein) along the side surface of the cap 1001. In one example, the arc is about 120°. In some embodiments, the lower part 1010 of the substrate which may include a sensing line) is on the neck of the bottle 702 and on or over the break line 1020. In bottles having a short neck, the bottle or cap may have a ferrite layer on or near the break line 1020.

In various embodiments, the substrate may be over a capsule. Additional evidence of tampering with the bottle and/or its contents includes tearing at the cap and glass boundary or, for twist caps, the metal-breaking boundary. Security tabs may be used to prevent intentional peeling (e.g., of the cap or the capsule). Existing wrap labelers advantageously work with or without minor changes to top bearing (e.g., such as those available from Krones, Inc., Franklin, Wis.) In exemplary embodiments, the lower part of the substrate 1010 may reach the neck or glass portion of the bottle, especially if there is a capsule that can be slipped off the bottle intact.

The substrates shown in FIGS. 9 and 10A-C are applicable for metal and/or screw caps. Additionally, the substrate may have a shape such as an hourglass shape. Generally, the antenna and integrated circuit are on the part of the substrate placed on and adhered to the bottle, and the sensor line(s) are on the part of the substrates attached to the cap. Alternatively, the antenna may be on the cap, and the sensing line may be on the bottle. When the antenna is placed on a metal cap, a ferrite layer may be placed on or over the antenna, or a relatively small antenna may be on the bottle. The ferrite layer may further a 3-4 mm spacer between it and the antenna, and the ferrite layer may act as an EMI shield when the antenna is not the open detection loop. The ferrite material may be printed on the substrate in various patterns, to avoid registration requirements and to stay clear of breaking points.

FIG. 11 shows an exemplary bottle 1100 having a substrate thereon (not shown) and a metal capsule 1130 on or over the substrate in accordance with one or more embodiments of the present invention. As shown in FIG. 11, a first part of the metal capsule 1130 may be on or over the neck of the bottle, and a second part of the metal capsule 1101 may be on or over at least part of a sealing device or mechanism (e.g., cap 1101). In exemplary embodiments, a strip or part 1131 between perforations 1120 across the metal capsule 1131 may be over a break line 1110.

To minimize any problems associated with opening the perforated metal capsule 1120 and tearing the sensing line on the substrate in one action, the sensing line may be under the capsule 1120 and/or the metal cap 1101. In such a case, two adhesives may be placed on either side of the sensing line (and/or substrate), in which one adhesive adheres the substrate and/or sensing line to the bottle, and another adhesive adheres the substrate and/or sensing line to the underside of the metal capsule 1130. For the side of the substrate and/or sensing line adhered to the inside of the metal capsule 1130, a heat-activated adhesive may be applied. In addition, the same or different heat-activated adhesive may be applied to a second (e.g., opposite) side of the substrate and/or sensing line that adheres to the bottle. In a production line, an exemplary method may include a cork or cork stopper being placed in the bottle, the substrate being subsequently placed on or over the bottle, the capsule 1130 being placed on or over the substrate and the bottle, and the bottle being secured with a capsule using a spinner. Thereafter, heat may be applied to the capsule 1130 (similar to the shrink wrap process) to activate the adhesive such that the adhesive adheres the substrate to the (metal) capsule and the bottle.

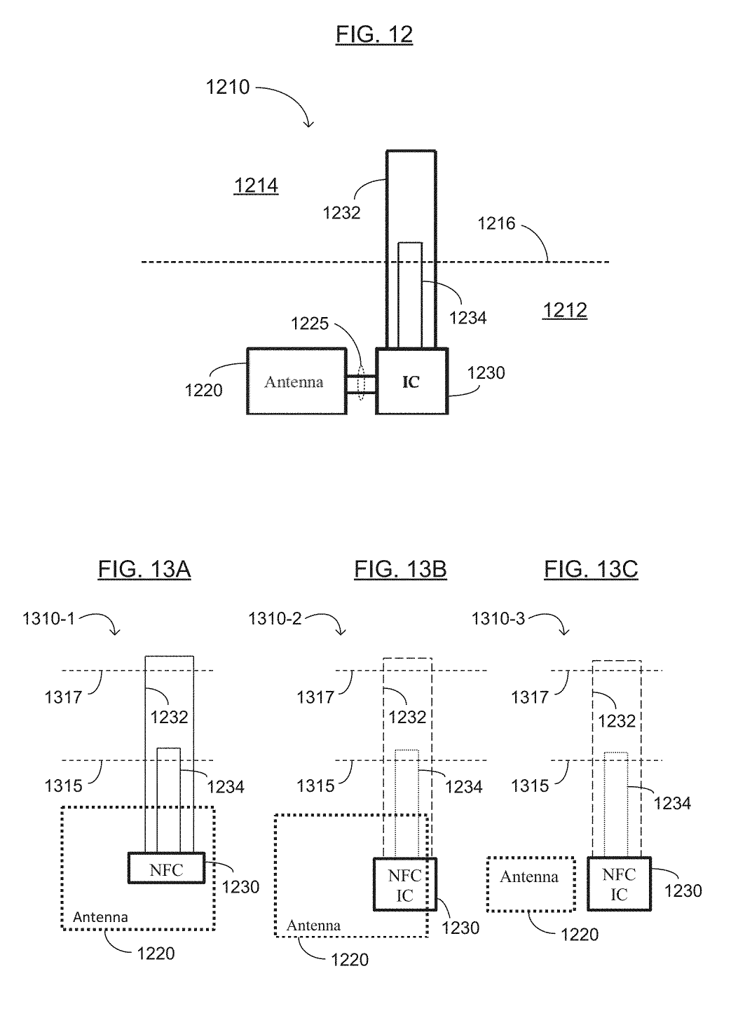

FIG. 12 shows an exemplary wireless communication device (e.g., a near field communication [NFC] or RF tag) 1210 having multiple sensing lines 1232 and 1234 according to one or more embodiments of the present invention. The device 1210 generally comprises a substrate (not shown), an integrated circuit (IC) 1230, an antenna 1220 in communication with the IC 1230 via traces 1225 on a bottle 1212, and sensing lines 1232 and 1234 in separate communication with the IC 1230 on the bottle 1212, a sealing device or mechanism 1214, and on or over a break line 1216. The sensing lines include a primary sensing line 1234 and a redundant sensing line 1236 in separate communication with the IC 1230. In such an arrangement, if the redundant sensing line 1232 is broken, but the primary sensing line 1234 is not, this may indicate that the product packaging has been tampered with, but the bottle has not been opened. This structure and/or device architecture is also applicable to radio frequency (RF) devices such as RFID tags, high frequency (HF) devices such as roll readers, etc.

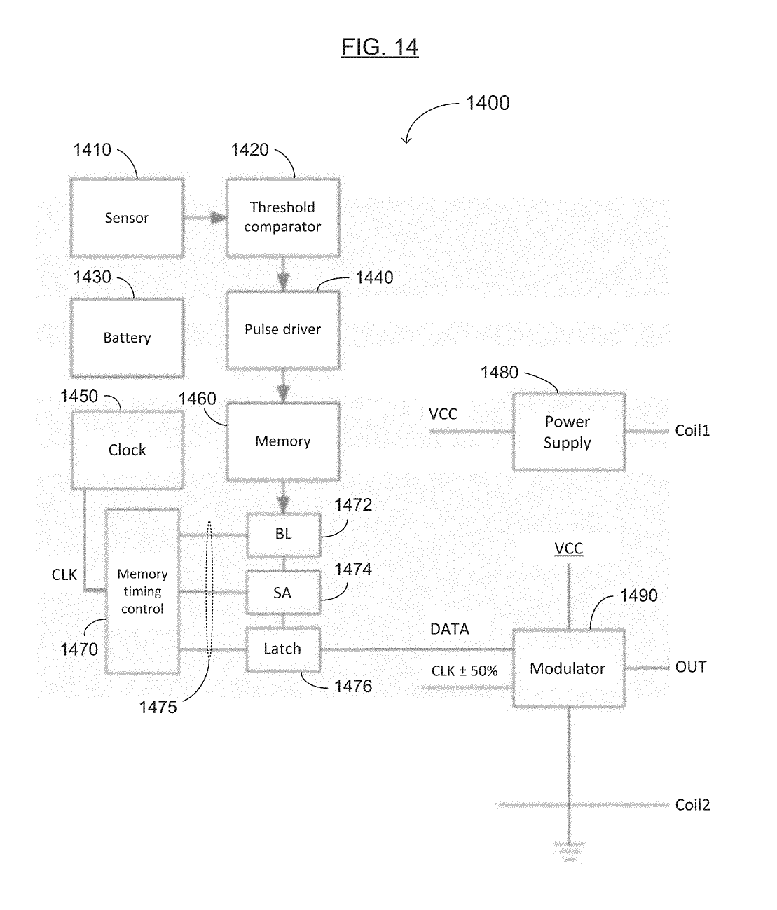

FIGS. 13A-C shows several alternative layouts for the relative positions of the IC 1230 and the antenna 1220 in the present wireless communication device. The sensing line 1232 and 1236 are in communication with the integrated circuit 1220 and on or over the break lines 1315 and 1317. For example, in a first embodiment 1310-1 (FIG. 13A), the antenna 1220 can completely overlap the IC 1230. In such an embodiment, the IC 1230 can be formed by thin film deposition and patterning techniques and/or printing on a thin, flexible substrate (e.g., an interposer) that extends over the loops of a spiral antenna and bridge the ends of the antenna 1220, and on which traces or pads can be formed to electrically connect the ends of the antenna 1220 to the IC 1230 (see, e.g., U.S. Pat. Appl. No. 11/243,460 [Attorney Docket No. IDR0272], filed Oct. 3, 2005, the relevant portions of which are incorporated herein by reference). Such an embodiment advantageously employs a single-layer spiral antenna. In an alternative embodiment 1310-2 (FIG. 13B), the antenna 1220 can partially overlap the IC 1230. This layout/embodiment may be advantageous when the antenna 1220 has a serpentine pattern, in which the two ends of the antenna 1220 can be in the same (relatively small) area of the substrate, enabling facile attachment of the IC 1230, directly or using pads or traces. In a third embodiment 1310-3 (FIG. 13C), the antenna 1220 and the IC 1230 do not overlap at all. Traces are necessary to connect the ends of the antenna 1220 to the IC 1230 in such a case, but electrical interference between the antenna 1220 and the IC 1230 is minimized or avoided in this embodiment.

Also, FIGS. 13A-C illustrate use of multiple sensing lines to sense continuity in more than one location or interface of the bottle. For example, some bottles include caps, corks, etc. and shrink wrap or a capsule thereover. Thus, there may be a first interface between the bottle and the cap or cork, and a second interface between the bottle and the shrink wrap or capsule. The device in FIGS. 13A-C may include at least two sensing lines 1232 and 1234 to sense opening or tampering with the bottle along either of two interfaces.

The first (e.g., outer) sensing line 1232 senses continuity of the bottle along the farthest of the two interfaces (e.g., between the bottle and the cap or cork), and the second (e.g., inner) sensing line 1234 senses continuity of the bottle along the nearest of the two interfaces (e.g., between the bottle and the shrink wrap or capsule). However, other arrangements and/or patterns for the sensing lines 1232 and 1234 can be envisioned and implemented without inventive activity by those skilled in the art.

FIG. 14 shows an exemplary integrated circuit (IC) 1400 for use with the present substrate or “smart label” that includes one or more sensors 1410, a threshold comparator 1420 receiving information (e.g., a signal) from the sensor(s) 1410, a pulse driver 1440 receiving an output of the threshold comparator 1420, a memory 1460 storing sensor data from the pulse driver 1440, one or more bit lines (BL) 1472 for reading data from the memory 1460, one or more sense amplifiers (SA) 1474 for converting the signal(s) on the bit line(s) to digital signals, one or more latches 1476 for temporarily storing data from the sense amplifier(s), and a transmitter (e.g., modulator) 1490 configured to output data (including an identification code) from the device. The exemplary IC 1400 in FIG. 14 also contains a clock 1450 configured to provide a timing signal (e.g., CLK) that controls the timing of certain operations in the IC 1400 and a memory timing control block or circuit 1470 that controls the timing of memory read operations. The modulator 1490 also receives the timing signal (CLK) from the clock circuit or a slowed-down or sped-up variation thereof. The exemplary IC 1400 also includes a power supply block or circuit 1480 that provides a direct current (e.g., VCC) to various circuits and/or circuit blocks in the IC. The memory 1460 may also contain identification code. The portion of the memory 1460 containing identification code may be printed. The IC 1400 may further contain a receiver (e.g., a demodulator), one or more rectifiers (e.g., a rectifying diode, one or more half-bridge or full-bridge rectifiers, etc.), one or more tuning or storage capacitors, etc. Terminals in the modulator and the power supply are connected to ends of the antenna (e.g., at Coil1 and Coil2).

The memory in an NFC or RF tag may contain a fixed number of bits. In some implementations, NFC tags may contain 128 or 256 bits. Some bits are allocated to overhead (non-payload) data for format identification and data integrity (CRC) checking. The payload of the device (e.g., the NFC or RF tag) consumes the remainder of the bits. For example, the payload can be up to 96 bits in the case of the 128-bit NFC tag and up to 224 bits in the case of the 256-bit NFC tag.

The payload of the NFC tag can be allocated to variable amounts of fixed ROM bits (which are generally—but not always—used as a unique identification number). When print methods are used in manufacturing the NFC tag, the ROM bits are permanently encoded and cannot be electrically modified. Any payload bits that are not allocated as fixed ROM bits can be allocated as dynamic sensor bits (e.g., for the continuity sensor to which the sensing lines 1232 and 1234 are connected). These sensor bits can change values, based on a sensed input. Different splits or allocations between ROM and sensor bits are indicated by data format bits that are part of the non-payload or ‘overhead’ bits, generally in the first 16 bits of the memory.

One example of how continuity sensing may be implemented in the present invention involves a sensor 1410 that detects when a sensing line is broken. Upon such an event, one or more sensor bits in the memory 1460 change state to reflect the broken or cut sensing line. This indicates to the reader (e.g., an NFC smartphone, etc.) that the protected container (e.g., bottle) has been opened. The ROM ID bits do not change, but any data integrity bits (e.g., for CRC) may be updated to reflect the state of the sensor bits.

Continuity sensing generally refers to a capability and/or function that senses or determines whether a container has been tampered with or opened on the one hand, or remains in a closed state (e.g., its factory-sealed condition) on the other hand. In one embodiment, continuity sensing is implemented using one or more sensing lines (e.g., lines 1232 and/or 1234 in FIG. 12). The present wireless communication device may be thought of as having two parts: a first part that includes the IC and the antenna, and a second part that includes the sensing line(s). The part of the wireless communication device that includes the IC and antenna is on a first part of the protected bottle/label. The part of the wireless communication device that includes the sensing line(s) is at least partially on a second part of the protected bottle/label and a sealing device or mechanism such as a cap or cork that moves relative to the bottle upon opening the bottle, so as to break the sensing line(s).

In addition to the primary sensing line(s), the present wireless communication device may include one or more redundant sensing lines. The redundant sensing line(s) can be used in an “AND”-type function with the primary sensing line(s) (e.g., the IC and sensor sense that the bottle is opened only when all of the primary sensing lines and redundant sensing lines are broken), or in an “OR”-type function with the sensing line(s) (e.g., the IC and sensor sense that the container is opened or has been tampered with when any of the primary sensing lines and redundant sensing lines are broken). Alternatively, the sensing lines and redundant sensing lines can provide one or more “partially-opened” continuity states when one or more of the primary sensing lines and redundant sensing lines are broken and one or more of the primary sensing lines and redundant sensing lines are not broken. One skilled in the art can easily derive logic and applications for such functionality and/or capability.

Of course, the IC in the present wireless device may include one or more other sensors in addition to the continuity sensor(s). For example, the IC can further include one or more temperature sensors, humidity sensors, electromagnetic field sensors, current/voltage/power sensors, light sensors, and/or chemical sensors (e.g., for oxygen, carbon monoxide, carbon dioxide, nitrogen oxides, sulfur dioxide and/or trioxide, ozone, one or more toxins, etc.). The present IC may also include one or more time sensors (e.g., configured to count or determine elapsed time), including the clock circuit (which can be a basis for a real-time clock) and one or more counters, dividers, etc., as is known in the art. The leads from any external sensing mechanism should be connected to the IC at terminals separate from those for the antenna and the continuity sensor. Such sensors should be on the same part of the substrate as the antenna and the IC.

Exemplary Methods of Labeling a Bottle With a Substrate With a Wireless Communication Device Thereon

The present invention also concerns a method of attaching a substrate to a bottle that includes placing the substrate on the bottle, and adhering (i) a first part of the substrate to a first portion of the bottle and (ii) a second part of the substrate to a second portion of the bottle and on or over a break line (e.g., between the bottle and a sealing device or mechanism). The substrate has a wireless communication device including an antenna, an integrated circuit, and a sensing line thereon. The first part of the substrate includes the antenna and integrated circuit, and the second part of the substrate includes the sensing line(s). The first portion of the bottle does not include the break line.

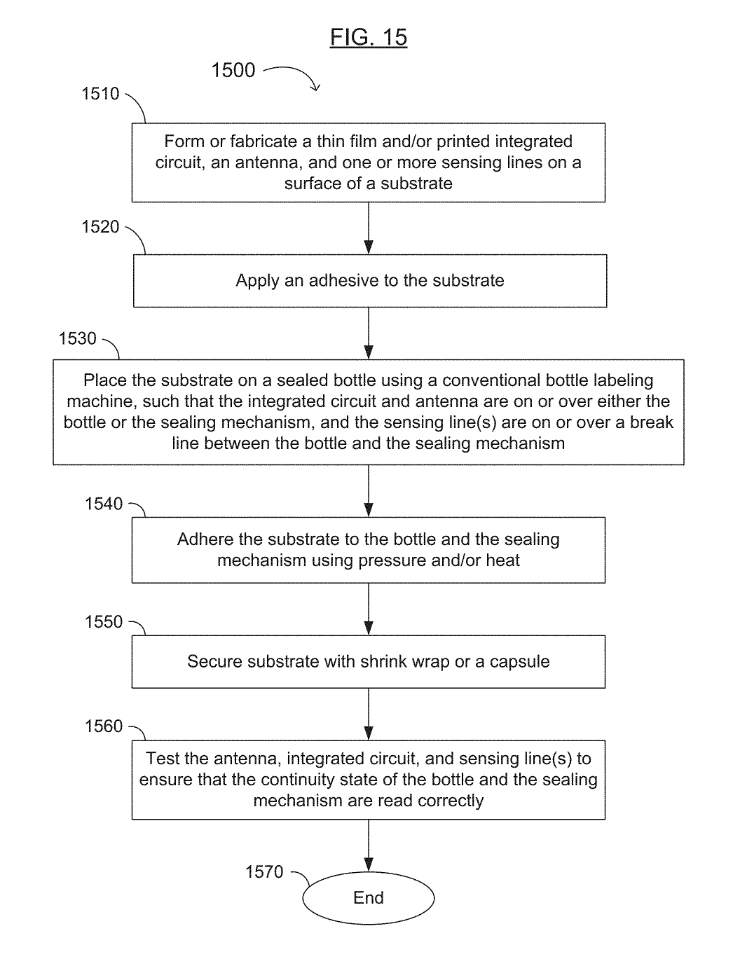

FIG. 15 shows a flow chart 1500 for an exemplary method of placing a substrate on a bottle. The substrate has a wireless communication (e.g., NFC and/or RF) device(s) thereon in accordance with one or more embodiments of the present invention. The present method advantageously provides electronic tags (e.g., “smart” labels) for bottles having various shapes and/or types that can be easily integrated into existing bottling or bottle labeling systems and/or machines without making changes to the existing system or machine.

At 1510, a thin film and/or printed integrated circuit, an antenna, and one or more sensing lines may be formed or fabricated on a surface of a substrate. Forming the integrated circuit may comprise printing one or more layers of the integrated circuit, and processing the remainder of the integrated circuit by thin film processing techniques. Printing offers advantages over photolithographic patterning processes, such as low equipment costs, greater throughput, reduced waste (and thus, a “greener” manufacturing process), etc., which can be ideal for relatively low transistor-count devices such as near field, RF and HF tags. Thus, in some cases, the method may comprise printing a plurality of the layers of the integrated circuit.

Alternatively, the method may form all layers of the integrated circuit by one or more thin film processing techniques. Thin film processing also has a relatively low cost of ownership, and is a relatively mature technology, which can result in reasonably reliable devices being manufactured on a wide variety of potential substrates. In some embodiments, the best of both approaches can be used, and the method may form one or more layers of the integrated circuit by one or more thin film processing techniques, and printing one or more additional layers of the integrated circuit.

Generally, the integrated circuit may have a first set of terminals electrically connected to the antenna. Also, the integrated circuit may have one or more terminals electrically connected to the sensing line. Typically, the sensing line terminal(s) are separate from the first set of terminals.

In some embodiments, forming the antenna may consist of forming a single metal layer on the substrate, and etching the single metal layer to form the antenna. Alternatively, forming the antenna may comprise printing a metal ink on the substrate in a pattern corresponding to the antenna. In some relatively advantageous embodiments, the antenna and the sensing line(s) consist of a single common metal layer on a common substrate. Alternatively, the antenna may consist of a first patterned metal layer on a first surface of the common substrate, and the sensing line(s) may consist of a second patterned metal layer on a second surface of the common substrate opposite from the first surface.

Alternatively, the sensing line(s) may be on a separate second substrate, and the antenna and the integrated circuit may be on a first (e.g., common) substrate. The second substrate having the sensing line(s) may be placed on or over the first substrate, such that the sensing line makes electrical contact and/or connection(s) to the integrated circuit.

At 1520, an adhesive may be applied to the substrate. Prior to placing the substrate on the bottle, the substrate may be guided to a gluing or adhesive station configured to apply glue or another adhesive to the substrate. In some embodiments, the adhesive may be applied to the same side of the substrate as the antenna, integrated circuit, and sensing line(s). Alternatively, the adhesive may be applied to the opposite surface of the substrate from the antenna, integrated circuit, and sensing line(s).

At 1530, the substrate having the adhesive thereon is placed on a bottle using the conventional bottle labeling machine of FIG. 1, as discussed above, or a similar conventional bottle labeling machine. In various embodiments, the substrate is placed on a sealed bottle, such that the integrated circuit and antenna are on or over either the bottle or the sealing device or mechanism, and the sensing line(s) are on or over a break line between the bottle and the sealing device or mechanism. Placing the substrate on the bottle may comprise or consist of applying the substrate to at least one part of the bottle (e.g., the neck, the shoulder, or the body) and at least part of the sealing device or mechanism (e.g., on or along the side surface and optionally, an uppermost surface), where the break line is between the bottle and the sealing device or mechanism. In some embodiments, a center part of the substrate is applied to the uppermost surface of the sealing device or mechanism.

For example, the label may be transferred to a vacuum surface in the bottle labeling machine that is not moving, then the bottle is brought into contact with the nonmoving vacuum surface. The bottle labeling machine may place or dispense the label onto the moving bottle lead edge first, with or without use of the vacuum surface, such that the label is partially adhered to the bottle, then the bottle is moved through a series of mechanisms or devices in the bottle labeling machine that push the label down smoothly along the neck and/or around one or more curves of the bottle, and in some instances, over the top of the bottle (i.e., the cap, cork or other sealing mechanism). Alternatively, the bottle labeling machine may transfer the label to a moving vacuum surface, and then transfer the label onto a moving bottle to partially or completely place the label in contact with the bottle.

In a further embodiment, placing the substrate on the bottle may including holding the substrate on a vacuum surface of the bottle labeling machine, as the bottles are circulated on a rotor with a labeling unit. Generally, the substrate is transferred to the bottle by wrapping or pressing the substrate while the bottle rotates. Typically, the vacuum surface may comprise at least one vacuum holder or pad configured to hold the substrate to the vacuum surface. In exemplary embodiments, the bottle may be transported to at least one labeling unit in the bottle labeling machine. Generally, the bottle may be transported using a conveyor, such as a conveyor belt. In addition, transporting the bottle may include guiding the bottle to a rotor, and circulating the bottle via a turntable, which may be driven by a motor or indexed by air.

Prior to placing the substrate on the bottle, the substrate may be held to the labeling unit by the vacuum surface. The vacuum surface may include at least one vacuum holder or pad, each vacuum holder or pad having one or more vacuum openings therein. The substrate is attached to the bottle by wrapping, wiping, or pressing the label onto the bottle in the direction of rotation of the vacuum surface. The substrate (e.g., label) may be applied semi-automatically, in which the bottle labeling machine tamps or pushes the substrate on to the top of the sealing device or mechanism and manually wipes or pushes the substrate down the side of the bottle (e.g., the neck and or shoulder). In addition, the substrate may be applied automatically. Generally, when the substrate is applied automatically, an additional labeling system may be placed on the end of existing line.

For example, referring back to FIG. 2, a first labelling system may apply the label 210 to the top of the bottle 200, and a second labelling system may push the lead edge and trailing edge of the label 210 (including the first and second parts 211 and 212) down along the neck 202 of the bottle 200. There are many mechanisms for applying labels to bottles in such a manner, and the selection of such mechanism(s) may depend on the expense and speed of the labelling system(s) and/or the rollers, linear cylinders, fixed guides, and cam or servo-driven fingers therein.

Referring now to FIG. 6B, the first part 630 of the label is applied to the side of the bottle 322 or 642, so that the part 631 of the label having the sensing line extends away from the neck of the bottle 622 or 642 (e.g., into the air). A second labelling system pushes a cam or servo-driven finger along the shoulder and neck of the bottle 622 or 642 to adhere the portion 631 of the label to the shoulder and neck of the bottle 622 or 642 and to the sealing mechanism 621 or 641. Although the automatic labeling process includes an additional step relative to the semi-automatic process, the steps may be run at faster speeds. When the substrate includes a medallion (see, e.g., label portion 311 in FIGS. 3A-C, label portion 630 in FIG. 6B, label portion 810 in FIG. 8, etc.), the various shapes of the substrate and locations of placement on the bottle may be used to minimize wrinkling of the substrate and/or conform the substrate to the bottle surface. For example, in FIGS. 3A-C, the medallion 311 minimizes wrinkles in the substrate because the underlying surface of the shoulder 326 of the bottle has a complex shape. It is generally beneficial to use multiple labeling tools, mechanisms and/or systems along the packaging line to adhere labels having such relatively wide medallions and relatively narrow portions to bottles.

Guiding the bottle to the labeling unit in an orientation transverse to the feeding direction may feed the upper portion of the substrate more quickly to the vacuum pad, which then attaches it to the bottle. In such orientation, the bottle is stopped, and thus movement of the bottle is slower, but controlled. If the substrate is oriented along a long axis thereof, then the vacuum pad is not absolutely necessary. Instead, the label and bottle speeds may be matched, and the label may be applied directly to the bottle, which gives an overall faster substrate/label application speed. The component that wipes down the substrate may be relatively expensive (e.g., $300-400K), and may not be equally applicable to all of the different bottle shapes and/or types.

In addition, when applying the substrate to a bottle having a relatively long neck (e.g., a wine bottle), the substrate may have a rectangular shape. Generally, rectangular shaped substrates are relatively long and narrow, thus requiring a relatively long antenna. When the substrate is relatively narrow, special equipment may be required to maneuver over a lip portion of the bottle to press the substrate on the bottle. In addition, when applying rectangular-shaped substrates, an axis of a web feed (e.g., a liner of the label material that the substrate is on) should be symmetrical to provide a balanced web feed. In addition, a back end of the bottle labeling process (e.g., where the substrate comes the web feed and on to the bottle) should be symmetrical, which advantageously prevents the substrates from twisting as substrates are being applied to the bottle.

In further embodiments of the present invention, placing the substrate on the bottle may include detaching the substrate from a carrier web (e.g., a labeling material) and applying the substrates to the bottle using one or more rollers. Typically, the carrier web may consist of paper, a semi-gloss paper, a paper/polymer laminate, a metal/polymer laminate, a metal/paper laminate, a transparent or non-transparent film, a glass/polymer laminate, a high temperature polymer, a metal foil such as aluminum, stainless steel or copper, or a combination thereof. Detaching the substrate from a carrier web may be accomplished using a detaching device and/or a cutting roller, prior to transferring the substrate to the vacuum surface. Generally, the substrate is adhered to the carrier web, which is coated with a low stick material, such as a liner, a release liner, or a backing. Thus, the substrate is transferred to the vacuum surface after the substrate is detached from the carrier web or labeling material (which may be, e.g., on a label spool).

In exemplary embodiments, the substrate may comprise a label, and the method may comprise placing and adhering the label to the bottle, the sealing device or mechanism, and over a break line between the bottle and sealing device or mechanism. Additionally or alternatively, the label may be placed and adhered on or to the substrate and the bottle.

At 1540, the substrate may be adhered to the bottle and the sealing device or mechanism using pressure and/or heat. In exemplary embodiments, a first part of the substrate including the antenna and the integrated circuit, and a second part of the substrate including the sensing line are adhered to the bottle and/or the sealing device or mechanism using the bottle labeling machine of FIG. 1, as discussed above, or a similar conventional bottle labeling machine, by applying pressure to the substrate.

In one embodiment, a center part of the substrate may be adhered to an uppermost surface of the sealing device or mechanism. Next, in such embodiment, one or more parts may be adhered to the side surface of the sealing device or mechanism and portions of the bottle by “wiping down” the substrate. For example, the first part including the antenna and integrated circuit may be adhered to the side of sealing device or mechanism. The second part of the substrate including the sensing line may be adhered to the break line, and the neck of the bottle by wiping downward from the sealing device. Wiping down the substrate may be semi-automatic or automatic. Alternatively, the part of the substrate including the antenna and integrated circuit may be adhered to the upper surface of the sealing device or mechanism, and the sensing line may be adhered to the side of the sealing device, the break line, and the neck by wiping the substrate down semi-automatically or automatically.

In another embodiment, the first part of the substrate including the antenna and integrated circuit may be adhered to the neck of the bottle. The first part of the substrate including the antenna and the integrated circuit may also be adhered to the shoulder and/or body of the bottle.

In exemplary embodiments, substrates having an asymmetric design or shape may automatically be wiped or pressed on the bottle using relatively higher speeds than substrates having a symmetrical design or shape. Alternatively, substrates having a symmetrical design or shape may automatically be adhered to the bottle using a tamp system at relatively lower speeds. The substrate may be also applied semi-automatically using conventional equipment, such as pressure sensitive labeling equipment (available from Tronics America, Inc., Merrillville, Ind.).

Additionally or alternatively, the second part of the substrate having the sensing line may be adhered to the neck of bottle, to the break line, and to at least a side surface of the sealing device or mechanism. Alternatively, the second part of the substrate including the sensing line may be placed on and adhered to at least one side surface of the sealing device or mechanism and to an uppermost surface of the sealing device or mechanism. Additionally or alternatively, the second part of the substrate including the sensing line may be adhered to the neck and/or the shoulder of the bottle.

In even further embodiments, the second part of the substrate including the sensing line may be adhered to the bottle by pressing or pushing up on the second part of the substrate along the bottle, on or over the break line, on the sealing device or mechanism (e.g., a cap) and along the side surface of the sealing device or mechanism. Adhering the first part of the substrate that includes the antenna and integrated circuit may comprise or consist of applying pressure along at least about a 90° arc (e.g., 90-180°, and in one example, a 120° arc) of the side surface of the sealing device or mechanism.

In various embodiments, the first part of the substrate including the antenna and the integrated circuit may be adhered or wiped onto a body and/or a shoulder of the bottle, and the second part of the substrate including the sensing line may be adhered (optionally subsequently) to the bottle, the sealing device or mechanism, and on, over, or across at least one break line by pressing or wiping the second part of the substrate (e.g., the “tail”) up along the neck of the bottle and towards the sealing device or mechanism semi-automatically.

In further embodiments of the present invention, the sensing line may include a plurality of sensing lines in the second part of the substrate. For example, first and second sensing lines may be adhered to the neck of the bottle, over the break line, and to a first side surface of the sealing device or mechanism, and the second sensing line may be further adhered to or over the uppermost surface of the sealing device or mechanism, a second side surface thereof, and along an opposite side of the neck of the bottle, and over the break line in a second location.

In even further embodiments, the second part of the substrate including the sensing line may be wiped on to the neck of the bottle, and on or over a break line.

Simultaneously or subsequently, the first part of the substrate including an antenna and the integrated circuit may be wiped on to the sealing device or mechanism.

In exemplary embodiments, the first part of the substrate including the antenna and integrated circuit may be wiped on and along the side surface of the sealing device or mechanism (e.g., the cap). Adhering the first part of the substrate may comprise or consist of applying pressure and wiping along the side surface of the sealing device or mechanism along at least a 90° arc (e.g., a 90-180° arc). Simultaneously or subsequently, the second part of the substrate including the sensing line may be wiped on to the neck and/or shoulder of the bottle, and over a break line. When bottles have relatively short necks, a ferrite layer may be deposited or printed on the substrate, at least in the area on or over the antenna.

At 1550, the substrate may be secured with a shrink wrap and/or a capsule subsequent to adhering the substrate to the bottle. In one example, a spinner secures the shrink wrap and/or a capsule to the bottle. Additionally, heat may be applied to the shrink wrap and/or capsule to activate the adhesive and adhere the substrate to the shrink wrap and/or capsule. Furthermore, the substrate may be adhered to the bottle and the sealing device or mechanism (e.g., directly when the substrate is under the shrink wrap and/or capsule, or indirectly when the substrate is over the shrink wrap and/or capsule).

In various embodiments, a first part of a metal capsule may be adhered to the bottle, a second part of the metal capsule may be adhered to a sealing device or mechanism, and the metal capsule may include perforations between the first and second parts (e.g., over or near the break line). To minimize any problems associated with opening the perforated metal capsule and tearing the sensing line on the substrate in one action, the sensing line may be under the capsule, and optionally, under the sealing device or mechanism (e.g., a metal cap). In such a case, two adhesives may be placed on either side of the sensing line (and/or substrate), in which one adhesive adheres the substrate and/or sensing line to the bottle, and another adhesive adheres the substrate and/or sensing line to the underside of the metal capsule. A heat-activated adhesive may be applied to a first side of the substrate and/or sensing line to adhere the substrate and/or sensing line to the inside of the metal capsule, and the same or different heat-activated adhesive may be applied to a second (e.g., opposite) side of the substrate and/or sensing line to adhere the substrate and/or sensing line to the bottle.

In a production line, an exemplary method includes placing a cork or stopper in the bottle, subsequently placing the substrate on or over the bottle and the cork or stopper, placing the capsule on or over the substrate, the bottle, and the cork or stopper, and optionally securing the bottle with a spinner. Thereafter, heat may be applied to the capsule (similar to the shrink wrap process) to activate the adhesive and adhere the substrate to the bottle and the metal capsule.

At 1560, the antenna, integrated circuit, and sensing line(s) may be tested to ensure that the continuity state of the bottle and the sealing device or mechanism are read correctly. The exemplary method of placing a substrate on a bottle, the substrate having a wireless communication (e.g., NFC and/or RF) device(s) in accordance with one or more embodiments of the present invention is complete at 1570.

### Conclusion

The present invention advantageously uses conventional vacuum-holding process for attaching substrates (e.g., labels) to bottles. The invention is not limited to only HF/NFC/13.56 MHz tags, and can be applied broadly to all wireless and display-based tags and labels, including RFID tags operating at frequencies higher or lower than 13.56 MHz, especially in the case where the RFID tag has the ability or functionality to accept external sensor input(s) and communicate the same when read by an RFID reader adapted to read such a tag. In addition, the present method and label advantageously provide a tap (e.g., read) location that is easy to find, a large antenna and satisfactory RF performance, intuitive phone access (e.g., due to the large antenna), and reader access after application of the label. The present invention provides an ideal solution for bottles having a short neck.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application. It is intended that the scope of the invention be defined by the claims appended hereto and their equivalents.

1. A method of attaching a substrate to a bottle, comprising:
a) placing the substrate on the bottle, the bottle having a break line, and the substrate having a wireless communication device having an antenna, an integrated circuit, and a sensing line thereon; and
b) adhering (i) a first part of the substrate including the antenna to a first portion of the bottle and (ii) a second part of the substrate including the sensing line to a second portion of the bottle and on or over a break line, wherein the first portion does not include the break line.

2. The method of claim 1, further comprising, prior to placing the substrate on the bottle, holding the substrate with a vacuum surface.

3. (canceled)

4. (canceled)

5. The method of claim 2, further comprising detaching the substrate from a carrier web using a detaching device and/or a cutting roller, prior to transferring the substrate to the vacuum surface.

6. (canceled)

7. The method of claim 1, wherein the bottle comprises a neck, a shoulder, and sealing device or mechanism, the break line comprises an interface between the bottle and the sealing device or mechanism.

8. (canceled)

9. (canceled)

10. The method of claim 7, wherein at least the second part of the substrate including the sensing line is placed on or over the sealing device or mechanism and the neck of the bottle and adhered to at least the neck of the bottle.

11. The method of claim 7, wherein placing the substrate comprises attaching the first part of the substrate including the antenna and integrated circuit to the shoulder of the bottle and attaching the second part of the substrate including the sensing line on the neck of bottle, on or over the break line, and on a side surface of a sealing device or mechanism.

12. The method of claim 7, wherein placing the substrate comprises attaching the first part of the substrate including the antenna and integrated circuit on the side of the sealing device or mechanism, and attaching the second part of the substrate including the sensing line on the neck and/or the shoulder of the bottle.

13-18. (canceled)

19. The method of claim 1, further comprising placing or adhering a label on or over the substrate on the bottle.

20-25. (canceled)

26. The method of claim 1, wherein the integrated circuit has a first set of terminals electrically connected to the antenna and a second set of one or more terminals electrically connected to the sensing line, and the second set of terminals are separate from the first set of terminals.

27-32. (canceled)

33. The method of claim 1, wherein the substrate comprises a slit, a notch, a score, and/or a perforation over the break line, configured to facilitate breaking, tearing, or severing the substrate and the sensing line. cm 34-38. (canceled)

39. The method of claim 1, further comprising placing a shrink wrap or a capsule over the substrate after adhering the substrate to the bottle.

40. (canceled)

41. (canceled)

42. The method of claim 3, wherein placing the substrate on the bottle comprises attaching the first part of the substrate including the antenna and integrated circuit on the shoulder of the bottle, and attaching the second part of the substrate including the sensing line on the neck of the bottle, and the side and/or top of the sealing device or mechanism.

43-46. (canceled)

47. A bottle having a sealing device or mechanism thereon and a substrate attached thereto, the substrate having a wireless communication device thereon, wherein:
a) an interface between the sealing device or mechanism and the bottle defines a break line;
b) the substrate is on or over the bottle, at least a part of the sealing device or mechanism, and the break line; and
c) the wireless communication device comprises an antenna, integrated circuit, and a sensing line;
d) a first part of the substrate including the antenna is on or over a first portion of the bottle or the sealing device or mechanism; and
e) a second part of the substrate including the sensing line is on or over at least a second portion of the bottle and over the break line.

48. The bottle of claim 47, wherein the bottle comprises a neck, a shoulder, and a body.

49. (canceled)

50. The bottle of claim 48, wherein the second part of the substrate including the sensing line is on the neck of the bottle and on or over the break line, and the first part of the substrate including the antenna and integrated circuit are on the neck and/or the shoulder of the bottle.

51. (canceled)

52. The bottle of claim 48, wherein the first part of the substrate with the antenna and integrated circuit is on the sealing device or mechanism, and the second part with the sensing line is on the neck and/or shoulder of the bottle.

53-55. (canceled)

56. The bottle of claim 48, wherein the first part of the substrate including the antenna and the integrated circuit are on a shoulder of the bottle, and the second part of the substrate including the sensing line is on or over the neck, the break line, and a side and/or top of the sealing device or mechanism.

57. The bottle of claim 47, wherein the second part of the substrate comprises a slit, a notch, a score, and/or a perforation over the break line, and the slit, notch, score, and/or perforation is configured to facilitate breaking, tearing, or severing the substrate and the sensing line.

58-62. (canceled)

63. The bottle of claim 47, wherein the substrate comprises a label.

64. The bottle of claim 47, further comprising a label on or over the substrate.

65. (canceled)

66. The bottle of claim 47, further comprising a shrink wrap or a capsule on or over the substrate.

67-83. (canceled)
